(19) United States
(12) Patent Application Publication
(10) Pub. No.: US 2025/0280969 A1
(43) Pub. Date: Sep. 11, 2025

(54) INFORMATION PROCESSING APPARATUS, INFORMATION PROCESSING METHOD, AND FIRMNESS ALTERABLE MODULE

(71) Applicant: Sony Group Corporation, Tokyo (JP)

(72) Inventors: Miyu IWAFUNE, Tokyo (JP); Masao KONDO, Kanagawa (JP); Junichi SHIMIZU, Tokyo (JP)

(73) Assignee: Sony Group Corporation, Tokyo (JP)

(21) Appl. No.: 18/851,070

(22) PCT Filed: Apr. 7, 2023
(86) PCT No.: PCT/JP2023/014325

§ 371 Date: Sep. 26, 2024

(30) Foreign Application Priority Data
Apr. 22, 2022 (JP) 2022-071121

(51) Int. Cl. A47C 31/12; G05D 15/01

(52) U.S. Cl. CPC A47C 31/123; G05D 15/01

(57) ABSTRACT

An information processing apparatus according to the present disclosure includes: an acquisition unit that acquires sensor information detected by a sensor; an estimation unit that estimates, based on the sensor information acquired by the acquisition unit, a contact mode of an object with respect to a target of which a firmness of a surface is alterable; and a determination unit that determines whether to alter the firmness of the surface of the target according to the contact mode of the object estimated by the estimation unit.

### FIELD

The present disclosure relates to an information processing apparatus, an information processing method, and a firmness alterable module.

### BACKGROUND

There is a conventionally known technique for altering a state of an object according to user's preference. For example, there is provided a technology that enables a user of a bed, which is an example of the object, to select a bed having firmness suitable for the user's own preference.

### CITATION LIST

### Patent Literature

Patent Literature 1: JP 2000-106979 A

### SUMMARY

### Technical Problem

However, the known technology cannot always ensure appropriate alteration of the firmness of the surface of the object. For example, the known technology needs an explicit instruction by the user in selecting the firmness, and the user needs to explicitly select the firmness each time the firmness is altered, and there is room for improvement in terms of usability. In addition, the known technology has not considered an issue of the shape of the surface of the object affected by adjusting the firmness. In this regard, the shape of the surface of the object greatly changes depending on the firmness, making it difficult to maintain a desired shape of the object surface. In this manner, when the firmness of the surface of an object is altered, there is room for improvement in terms of usability and the shape of the surface, and it is desired to be able to appropriately alter the firmness of the surface of an object.

In view of this, the present disclosure proposes an information processing apparatus, an information processing method, and a firmness alterable module capable of appropriately altering the firmness of the surface of an object.

### Solution to Problem

According to the present disclosure, an information processing apparatus includes an acquisition unit that acquires sensor information detected by a sensor; an estimation unit that estimates, based on the sensor information acquired by the acquisition unit, a contact mode of an object with respect to a target of which a firmness of a surface is alterable; and a determination unit that determines whether to alter the firmness of the surface of the target according to the contact mode of the object estimated by the estimation unit.

### BRIEF DESCRIPTION OF DRAWINGS

FIG. 1 is a diagram illustrating an example of information processing according to an embodiment of the present disclosure.

FIG. 2 is a diagram illustrating a configuration example of an information processing system according to the embodiment of the present disclosure.

FIG. 3 is a diagram illustrating a configuration example of an information processing apparatus according to the embodiment of the present disclosure.

FIG. 4 is a diagram illustrating an example of a module information storage unit according to the embodiment of the present disclosure.

FIG. 5 is a diagram illustrating an example of a history information storage unit according to the embodiment of the present disclosure.

FIG. 6 is a diagram illustrating an example of a sensor information storage unit according to the embodiment of the present disclosure.

FIG. 7 is a diagram illustrating an example of an alteration condition information storage unit according to the embodiment of the present disclosure.

FIG. 8 is a diagram illustrating a configuration example of a firmness alterable module according to the embodiment of the present disclosure.

FIG. 9 is a plan view illustrating a main part of the firmness alterable module.

FIG. 10 is a side view illustrating the main part of the firmness alterable module.

FIG. 11 is a side view illustrating the main part of the firmness alterable module.

FIG. 12 is a diagram illustrating an arrangement example of a plurality of firmness alterable modules.

FIG. 13 is a flowchart illustrating a procedure of information processing according to the embodiment of the present disclosure.

FIG. 14 is a flowchart illustrating a procedure of processing according to pressure.

FIG. 15 is a diagram illustrating an example of alteration according to an adjacent module.

FIG. 16 is a flowchart illustrating a procedure of processing according to a pressure change pattern.

FIG. 17 is a conceptual diagram illustrating an example of alteration according to object detection.

FIG. 18 is a flowchart illustrating a procedure of processing according to object detection.

FIG. 19 is a conceptual diagram illustrating an example of alteration according to a context.

FIG. 20 is a conceptual diagram illustrating an example of alteration according to a context.

FIG. 21 is a flowchart illustrating a procedure of processing according to a context.

FIG. 22 is a flowchart illustrating a procedure of processing according to a user.

FIG. 23 is a conceptual diagram illustrating an example of alteration according to a physical part of a user.

FIG. 24 is a flowchart illustrating a procedure of processing according to a physical part of a user.

FIG. 25 is a conceptual diagram illustrating an example of alteration according to a force applied to a user.

FIG. 26 is a flowchart illustrating a procedure of processing according to a force applied to a user.

FIG. 27 is a hardware configuration diagram illustrating an example of a computer that implements an information processing apparatus or functions of the information processing apparatus.

### DESCRIPTION OF EMBODIMENTS

Embodiments of the present disclosure will be described below in detail with reference to the drawings. Note that the information processing apparatus, the information processing method, and the firmness alterable module according to the present application are not limited by the embodiments. Moreover, in each of the following embodiments, the same parts are denoted by the same reference symbols, and a repetitive description thereof will be omitted.

The present disclosure will be described in the following order.
1. Embodiments
1-1. Overview of information processing according to embodiment of present disclosure
1-2. Configuration of information processing system according to embodiment
1-3. Configuration of information processing apparatus according to embodiment
1-4. Configuration of firmness alterable module according to embodiment
1-4-1. Configuration example of object using firmness alterable module
1-5. Processing example
1-5-1. Information processing procedure according to embodiment
1-5-2. Processing example according to pressure
1-5-3. Example of processing according to object detection
1-5-4. Processing example according to context
1-5-5. Processing example according to user
1-5-6. Processing example according to force applied to user
1-5-7. Other information examples
2. Other embodiments
2-1. Other configuration examples 2-2. Others
3. Effects according to present disclosure
4. Hardware configuration

### 1. EMBODIMENTS

### 1-1. Overview of Information Processing According to Embodiment of Present Disclosure

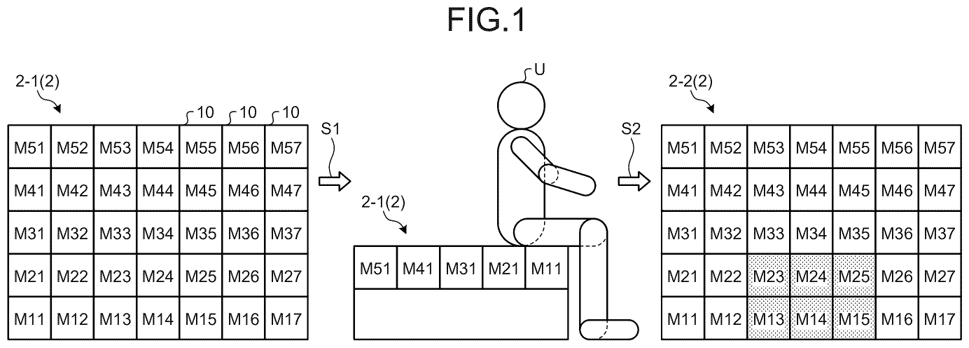

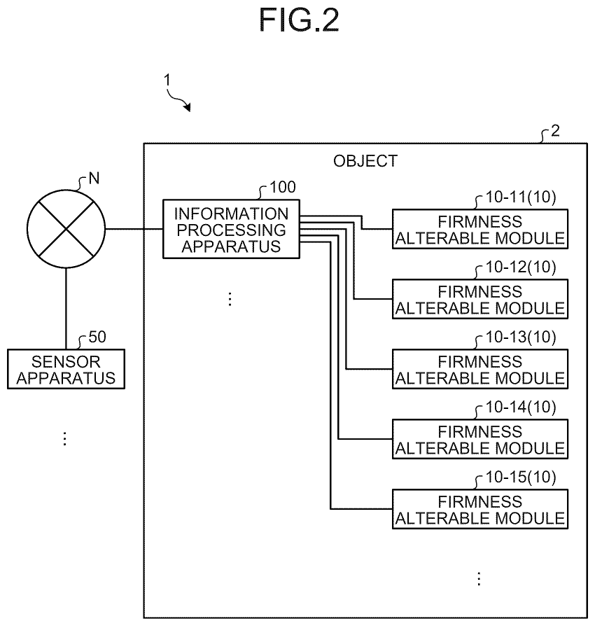

FIG. 1 is a diagram illustrating an example of information processing according to an embodiment of the present disclosure. The information processing according to the embodiment of the present disclosure is implemented by an information processing system 1 including an information processing apparatus 100 and a firmness alterable module 10 (hereinafter, also simply referred to as a “module”) as illustrated in FIG. 2. Details of the information processing system 1 will be described with reference to FIG. 2.

FIG. 1 will be used to describe an exemplary case where an object 2, which is a target in which the firmness of the surface is alterable, is a sofa. However, the object 2 is not limited to a sofa, and may be any object as long as the object 2 is a tangible object having a face (surface) with which another object comes into contact. For example, the object 2 may be a desk, an automobile seat, a cushion, or the like. In FIG. 1, the object 2 before the firmness alteration is described as an “object 2-1”, and the object 2 after the firmness alteration is described as an “object 2-2”. However, the object 2 will be described as the object 2 when described with no particular distinction from each other. The object 2-1 on which the user U1 sits in FIG. 1 indicates the object 2 as a side view, and other objects 2-1 and 2-2 indicate plan views (top views) of the object 2 viewed from above the seat surface of the object 2.

In FIG. 1, the object 2 being a sofa has its seat surface on which a person sits includes a plurality of firmness alterable modules 10. Specifically, the seat surface of the object 2 includes 35 firmness alterable modules 10 indicated by 5×7 rectangular regions. Incidentally, the object 2 being a sofa may have the seat surface on which a person sits constituted with one firmness alterable module 10.

FIG. 1 assigns M and two-digit numbers such as “M **” (* is a number) to 5×7 rectangular regions each corresponding to each of 35 firmness alterable modules 10 so as to make each of the firmness alterable modules 10 distinguishable from each other. Specifically, in FIG. 1, M11 to M57 are assigned individually to the 5×7 rectangular regions so as to distinguishably describe the 35 firmness alterable modules 10 (hereinafter also referred to as “modules M11 to M57”) provided in the object 2 being a sofa.

For example, the module M11 is the firmness alterable module 10 located at the left corner of the object 2 in plan view from the seat surface side of the object 2. The module M21 is the firmness alterable module 10 disposed on the upper side of the module M11 in plan view from the seat surface side of the object 2. The module M12 is the firmness alterable module 10 disposed on the right side of the module M11 in plan view from the seat surface side of the object 2.

For example, the module M34 is the firmness alterable module 10 located at the center of the object 2 in plan view from the seat surface side of the object 2. The module M24 is the firmness alterable module 10 disposed on the lower side of the module M34 in plan view from the seat surface side of the object 2. The module M33 is the firmness alterable module 10 disposed on the left side of the module M34 in plan view from the seat surface side of the object 2.

For example, the module M11 corresponds to a firmness alterable module 10-11 in FIG. 2, and the module M12 corresponds to a firmness alterable module 10-12 in FIG. 2. In addition, the module M13 corresponds to a firmness alterable module 10-13 in FIG. 2, the module M14 corresponds to a firmness alterable module 10-14 in FIG. 2, and the module M15 corresponds to a firmness alterable module 10-15 in FIG. 2. Each of the modules M11 to M57 is described as the firmness alterable module 10 or simply the module when described with no particular distinction from each other.

First, when the user U sits on the seat surface of the object 2 as a sofa, a pressure applied to the seat surface of the object 2 is detected. FIG. 1 illustrates, as an example, a case where a user U sits on regions corresponding to modules M13, M14, M15, M23, M24, and M25 on the seat surface of an object 2. For example, the object 2 is provided with a pressure sensor corresponding to each of the 35 modules, and each pressure sensor detects the pressure applied to each of the 35 modules provided on the seat surface of the object 2. Each of the modules includes a pressure sensor and transmits the detected pressure to the information processing apparatus 100. With this configuration, the information processing apparatus 100 acquires sensor information indicating the pressure applied to the object 2 by the user U (step S1).

The information processing apparatus 100 determines whether to alter the firmness of the surface of the object 2 based on the acquired sensor information (step S2). In FIG. 1, the information processing apparatus 100 determines which region of the seat surface of the object 2 is to undergo firmness alteration based on the acquired sensor information. The information processing apparatus 100 estimates a contact mode of a user U1 with respect to the object 2. The information processing apparatus 100 calculates a change amount in the pressure applied by the user U to each of the 35 modules of the object 2 based on the change amount in the pressure detected by each pressure sensor.

The information processing apparatus 100 determines a module in which the change amount in the pressure applied by the user U satisfies a condition, among the 35 modules of the object 2, as a module to undergo firmness alteration. For example, the information processing apparatus 100 determines a module in which the change amount in the pressure applied by the user U is a predetermined threshold or more, among the 35 modules of the object 2, as a module to undergo firmness alteration (also referred to as “alteration target module”).

In FIG. 1, the information processing apparatus 100 determines six modules of modules M13, M14, M15, M23, M24, and M25 as alteration target modules among 35 modules provided in the object 2 being a sofa. That is, the information processing apparatus 100 determines to soften, that is, decrease the firmness of the six modules M13, M14, M15, M23, M24, and M25 corresponding to the regions of the object 2 where the user U sits.

Furthermore, the information processing apparatus 100 may determine that the larger the change amount in the pressure of the alteration target module, the larger the alteration amount in the firmness of the alteration target module. In FIG. 1, the information processing apparatus 100 may determine the alteration amount in the firmness of the module M24 so that the module M24 is to be softer than others among the six modules of the modules M13, M14, M15, M23, M24, and M25 which are alteration target modules.

The information processing apparatus 100 transmits instruction information (control information) instructing firmness alteration to each alteration target module. The information processing apparatus 100 transmits instruction information indicating a firmness alteration amount to each alteration target module. In FIG. 1, the information processing apparatus 100 transmits instruction information instructing the firmness alteration to six modules of modules M13, M14, M15, M23, M24, and M25, which are alteration target modules. For example, the information processing apparatus 100 transmits, to the module M13, instruction information instructing firmness alteration on the surface of the module M13.

Having received the instruction information from the information processing apparatus 100, each alteration target module alters the firmness of the surface based on the instruction information. The six modules of the modules M13, M14, M15, M23, M24, and M25 alter the firmness of the surface based on the instruction information. For example, the module M13 executes processing of altering the firmness of the surface based on the instruction information received from the information processing apparatus 100. With this configuration, the object 2 can soften regions corresponding to the six modules of the modules M13, M14, M15, M23, M24, and M25 in the seat surface. Details of the configuration of implementing the alteration of firmness in the firmness alterable module 10 will be described below.

As described above, based on the sensor information, the information processing apparatus 100 determines whether to alter the firmness of the surface of the object 2 whose firmness of the surface is alterable, making it possible to appropriately alter the firmness of the surface of the object. Furthermore, the firmness alterable module 10 provided in the object 2 alters the firmness in accordance with an instruction from the information processing apparatus 100, making it possible to appropriately alter the firmness of the surface of the object.

Conventionally, the firmness of a seat surface of a product such as desk or a sofa is a firmness unique to the product. However, depending on the use condition, there are cases where the firmer one is more comfortable to use and where the softer one is better. For example, in the case of a desk, it is more appropriate to have a firm flat surface as usual when writing on the desk, but it is more appropriate to have a soft surface such as a cushion when sleeping with one's head down or placing an object that easily rolls.

On the other hand, it is possible to increase the firmness of a soft material by compressing the material, but it is difficult to maintain the surface shape. Moreover, it is possible to solve the issue of maintaining the surface shape by stacking a material different from the compressive material on the surface, but it is difficult to express softness with a material having firmness enough to maintain the surface shape.

In view of these, it is desirable to have a mechanism that can withstand deformation during compression and behaves to provide softness in normal times. Therefore, the information processing system 1 uses a structure in which softness is achieved not by firmness of the material but by a structure having a desired behavior so as to be able to withstand deformation during compression and behaves to provide softness in normal times. In the information processing system 1, the structure of the firmness alterable module 10 is a structure that exhibits behavior that is deformed by a force from the positive direction of the axis and is unlikely to be deformed by a force from the negative direction. With this structure, the information processing system 1 can actualize an interface that can adaptively alter the firmness using a mechanism that can alter the firmness while maintaining the surface shape. The information processing system 1 can perform driving at a deformation speed at which firmness can be altered while maintaining a surface shape and which can cope with daily movements of a person.

As described above, by using the firmness alterable module 10 having a structure that exhibits a behavior unlikely to be deformed against a force applied during compression, the information processing system 1 can actualize a mechanism capable of maintaining a surface shape during compression while maintaining softness during normal times. Details of the structure of the firmness alterable module 10 will be described below.

### 1-2. Configuration of Information Processing System According to Embodiment

The information processing system 1 illustrated in FIG. 2 will be described. FIG. 2 is a diagram illustrating a configuration example of the information processing system according to the embodiment of the present disclosure. The information processing system 1 illustrated in FIG. 2 may include a plurality of information processing apparatuses 100 and a plurality of sensor apparatuses 50. As illustrated in FIG. 2, the information processing system 1 includes the information processing apparatus 100, a plurality of firmness alterable modules 10-11, 10-12, 10-13, 10-14, and 10-15, and the sensor apparatus 50. Hereinafter, when the firmness alterable modules 10-11 to 10-15 may be referred to as the firmness alterable module 10 when not distinguished from each other.

FIG. 2 illustrates a case where the information processing apparatus 100 is disposed in the object 2. Although FIG. 2 illustrates only the five firmness alterable modules 10-11 to 10-15, the object 2 may include more than five (for example, 20 or 100 or more) firmness alterable modules 10. Furthermore, the object 2 may include four or less firmness alterable modules 10. For example, the object 2 may include one firmness alterable module 10.

The information processing apparatus 100 controls the firmness alterable module 10. For example, the information processing apparatus 100 is connected to the firmness alterable module 10 by wired connection, and transmits and receives information to and from the firmness alterable module 10. Furthermore, the information processing apparatus 100 is communicably connected to the sensor apparatus 50 by a wired or wireless connection via a predetermined network N.

The information processing apparatus 100 is a computer that determines whether to alter the firmness of the surface of the target in which the firmness of the surface is alterable, based on sensor information detected by a sensor. The information processing apparatus 100 is used to provide a service related to alteration in firmness of the object 2 equipped with the firmness alterable module 10. The information processing apparatus 100 performs various types of information processing related to the alteration in firmness of the firmness alterable module 10.

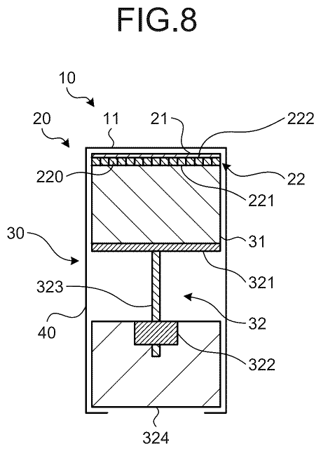

The firmness alterable module 10 includes the surface constituting at least a part of the surface of the object 2. In FIG. 1, the firmness alterable module 10 constitutes a seat surface portion of the object 2 being a sofa. The firmness alterable module 10 is a module capable of altering its firmness. Details of the configuration of the firmness alterable module 10 will be described with reference to FIG. 8 and subsequent drawings.

The sensor apparatus 50 detects various types of sensor information. The sensor apparatus 50 may be an image sensor (camera) that captures an image. The sensor apparatus 50 being an image sensor is disposed around the object 2 and images the object 2. For example, the sensor apparatus 50 being an image sensor images another object such as a person in contact with the object 2.

Note that the sensor apparatus 50 is not limited to the image sensor, and may be various sensors. For example, the sensor apparatus 50 may be a sound sensor (microphone) that detects sound. For example, the sensor apparatus 50 being a sound sensor collects user's utterance, ambient environmental sound, and the like.

Furthermore, the sensor apparatus 50 may be a sensor that detects various biological signals, such as a heart rate sensor that detects a heart rate of the user, an electroencephalogram sensor that detects an electroencephalogram of the user, a pulse sensor (pulse wave sensor) that detects a pulse of the user, a respiration sensor (exhalation sensor) that detects respiration of the user, and a perspiration sensor that detects perspiration of the user. Furthermore, the sensor apparatus 50 may be a sensor that detects various types of information such as temperature, humidity, illuminance, position, acceleration, light, pressure, gyro, and distance.

The sensor apparatus 50 transmits various sensor information detected by various sensors to the information processing apparatus 100. Note that the above is an example, and the sensor apparatus 50 is not limited to the above, and may be various sensors. In addition, the sensor to detect the various types of information described above in the sensor apparatus 50 may be the same type of sensors or may be different types of sensors.

### 1-3. Configuration of Information Processing Apparatus According to Embodiment

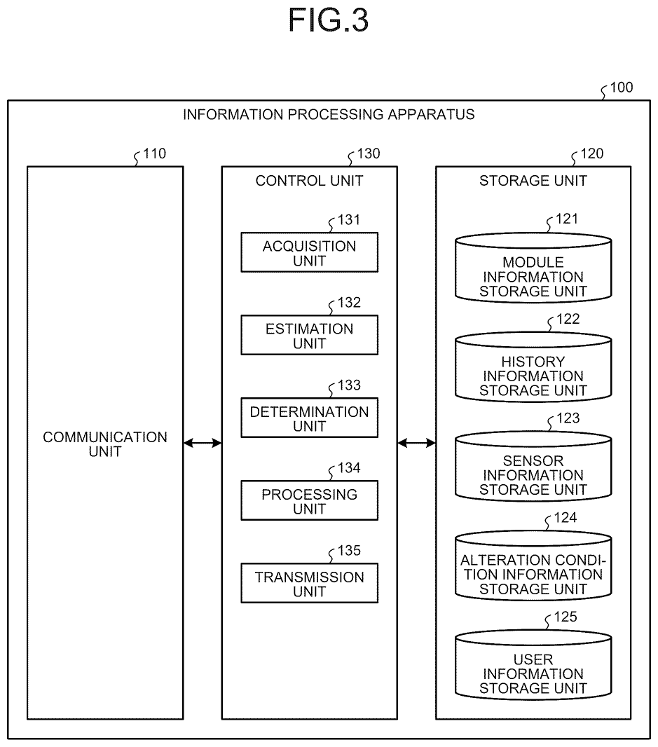

Next, a configuration of an information processing apparatus 100 which is an example of an information processing apparatus that executes information processing according to an embodiment will be described. FIG. 3 is a diagram illustrating a configuration example of the information processing apparatus 100 according to the embodiment of the present disclosure.

As illustrated in FIG. 3, the information processing apparatus 100 includes a communication unit 110, a storage unit 120, and a control unit 130. The information processing apparatus 100 may include an input unit (for example, a keyboard, a mouse, etc.) that receives various operations from an administrator or the like of the information processing apparatus 100, and a display unit (for example, a liquid crystal display, etc.) for displaying various types of information.

The communication unit 110 is implemented by a network interface card (NIC), for example. The communication unit 110 is connected to the network N (refer to FIG. 2) in a wired or wireless channel, and transmits/receives information to/from another information processing apparatus such as the sensor apparatus 50. The communication unit 110 may communicate with the firmness alterable module 10 and transmit and receive information to and from the firmness alterable module 10.

The storage unit 120 is implemented by semiconductor memory elements such as random access memory (RAM) and flash memory, or other storage devices such as a hard disk or an optical disc. As illustrated in FIG. 3, the storage unit 120 according to the embodiment includes a module information storage unit 121, a history information storage unit 122, a sensor information storage unit 123, an alteration condition information storage unit 124, and a user information storage unit 125.

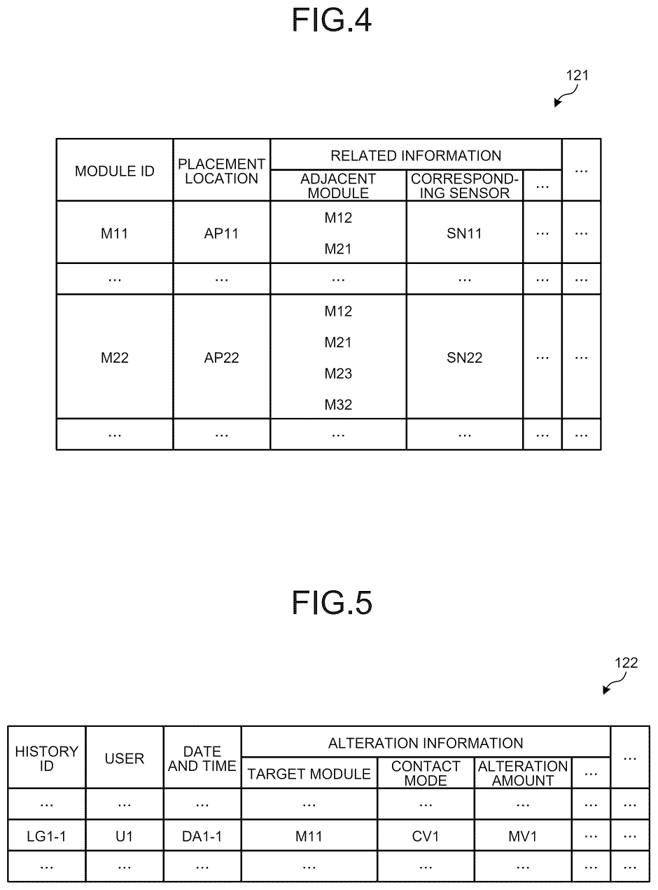

The module information storage unit 121 according to the embodiment stores various types of information related to the module. For example, the module information storage unit 121 can communicate with the information processing apparatus 100 and stores various types of information of modules that can be target modules. FIG. 4 is a diagram illustrating an example of a module information storage unit according to the embodiment of the present disclosure. The module information storage unit 121 illustrated in FIG. 4 includes items such as “module ID”, “placement location”, and “related information”.

The “module ID” indicates identification information for identifying a module. The “module ID” is provided in the object and indicates identification information for identifying each module to be controlled by the information processing apparatus 100. Further, the “placement location” indicates an arrangement place of the module. “Placement location” indicates a placement location of the module in the object and a location at which the surface is to be formed by the module.

The “related information” stores information related to the module. For example, the “related information” stores various types of information indicating a relationship with another module, a sensor that detects the module, and the like. The “related information” includes items such as “adjacent module” and “corresponding sensor”.

The “adjacent module” indicates a module adjacent to the module (adjacent module). For example, the “adjacent module” stores information (module ID) identifying an adjacent module which is adjacent to the module on its side surface. For example, “adjacent module” indicates modules disposed in four directions, namely, upper, lower, left, and right directions of the module in plan view.

“Corresponding sensor” indicates a sensor (corresponding sensor) that performs detection related to the module. The “corresponding sensor” stores information (sensor ID or the like) identifying a corresponding sensor. For example, the “corresponding sensor” stores information identifying a pressure sensor that detects pressure on the module.

FIG. 4 illustrates that the module (module M11) identified by the module ID “M11” is disposed at a placement location AP11. For example, the placement location AP11 indicates that the module M11 is placed at the lower left corner of the object 2. For example, the module M11 corresponds to the firmness alterable module 10-11.

In addition, the diagram indicates that the adjacent module of the module M11 is a module (module M12) identified by the module ID “M12” and a module (module M21) identified by the module ID “M21”. The corresponding sensor of the module M11 is indicated as a sensor identified by the sensor ID “SN11”. For example, the diagram indicates that the corresponding sensor of the module M11 is a pressure sensor identified by the sensor ID “SN11” and that the pressure sensor identified by the sensor ID “SN11” detects the pressure on the module M11. That is, the pressure value detected by the pressure sensor identified by the sensor ID “SN11” indicates the pressure applied to the module M11.

The module information storage unit 121 may store various types of information according to a purpose, not limited to the above.

The history information storage unit 122 according to the embodiment stores various types of information related to a use history of the object. For example, the history information storage unit 122 stores history information including information such as a user who has used the object, a use date and time, and detailed information regarding the alteration. FIG. 5 is a diagram illustrating an example of a history information storage unit according to the embodiment of the present disclosure. The history information storage unit 122 illustrated in FIG. 5 includes items such as “history ID”, “user”, “date and time”, and “alteration information”.

“History ID” indicates identification information for identifying history information. The “user” indicates identification information for identifying an entity using an object. When the firmness is altered in the absence of user and there is no corresponding user, the “user” stores information (NULL or the like) indicating that there is no corresponding user. The “date and time” indicates a date and time corresponding to each history ID. For example, “date and time” indicates a date and time of occurrence of alteration corresponding to each history ID. In FIG. 5, “date and time” is illustrated in an abstract manner such as “DA1-1”, but a specific date and time such as “17:36:52, Apr. 11, 2022” may be stored.

The “alteration details” stores alteration information indicating details of the alteration in firmness of an object. The “history information” includes items such as a “target module”, a “contact mode”, and a “alteration amount”. The “target module” indicates a module being a target of the firmness alteration. A “contact mode” refers to a mode of contact made by another object with the corresponding module. For example, the “contact mode” stores information related to contact made by another objects with the corresponding module, such as a change in pressure to the module. The “alteration amount” indicates alteration amount in the firmness of the corresponding module. For example, the “alteration amount” stores information indicating to which firmness the module is to be altered.

In FIG. 5, the history information (history information LG1-1) identified by the history ID “LG1-1” indicates alteration in firmness performed on the date and time DA1-1 by the user identified as the user U1. the alteration in the firmness corresponding to the history information LG1-1 indicates that the target module is the module M11. The history information LG1-1 indicates that the firmness of the module M11 having a contact mode CV1 at the date and time DA1-1 has been altered to the firmness corresponding to the alteration amount MV1.

Note that the history information storage unit 122 may store various types of information according to a purpose, not limited to the above.

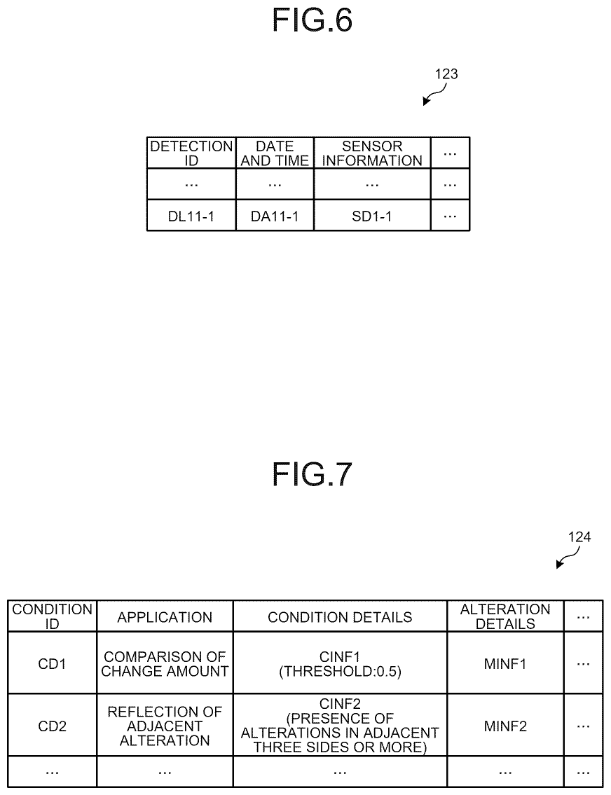

The sensor information storage unit 123 according to the embodiment stores various types of information related to the sensor. FIG. 6 is a diagram illustrating an example of a sensor information storage unit according to the embodiment of the present disclosure. For example, the sensor information storage unit 123 stores various sensor information detected by the sensor apparatus 50. The sensor information storage unit 123 illustrated in FIG. 6 includes items such as “detection ID”, “date and time”, and “sensor information”.

The “detection ID” indicates identification information for identifying the acquired sensor information. The “date and time” indicates a date and time corresponding to each detection ID. For example, the “date and time” indicates date and time of acquisition of the sensor information corresponding to each detection ID. In the example of FIG. 6, the “date and time” is illustrated in an abstract manner such as “DA11-1”, but a specific date and time such as “16:47:28, Apr. 11, 2022” may be stored.

The “sensor information” indicates detected sensor information. The “sensor information” stores various types of information according to the type of detected information. For example, the “sensor information” stores image information, pressure information indicating pressure, and the like.

In the example of FIG. 6, the detection identified by the detection ID “DL11-1” (detection DL11-1) indicates sensing corresponding to the date and time DA11-1. The detection DL11-1 indicates that the sensor information SD1-1 is acquired (detected).

The sensor information storage unit 123 may store various types of information according to a purpose, not limited to the above. For example, the sensor information storage unit 123 may store information identifying the sensor apparatus 50 corresponding to each detection. For example, the sensor information storage unit 123 may store information indicating the position of the sensor apparatus 50 at the date and time corresponding to each detection ID. For example, the sensor information storage unit 123 may store position information such as latitude and longitude of the sensor apparatus 50 at a date and time corresponding to each detection ID.

The alteration condition information storage unit 124 according to the embodiment stores various types of information related to the firmness alteration condition. The alteration condition information storage unit 124 stores various types of information related to a condition used for judging whether to alter the firmness. FIG. 7 is a diagram illustrating an example of an alteration condition information storage unit according to the embodiment. The alteration condition information storage unit 124 illustrated in FIG. 7 includes items such as “condition ID”, “application”, “condition details”, and “alteration details”.

The “condition ID” indicates identification information for identifying the condition. “Application” indicates application of the condition. The “condition details” stores information used for judgment (determination) as to whether to alter the firmness. FIG. 7 illustrates an example of storing conceptual information such as “CINF1” in the “condition details”. However, information actually stored includes a threshold used for judgment, information indicating a specific condition such as when to alter firmness, or a file path name indicating a storage location.

The “alteration details” indicates information of alteration performed when a corresponding condition is satisfied. FIG. 7 illustrates an example of stored conceptual information such as “MINF1” in the “alteration details”. However, information actually stored includes specific information indicating a target firmness due to the alteration, such as a pressure value applied to a flexible member corresponding to the firmness after the alteration, or a file path name indicating its storage location.

In the example of FIG. 7, the condition (condition CD1) identified by the condition ID “CD1” is a condition used for change amount comparison represented by a condition as illustrated in condition details CINF1. In FIG. 7, the condition CD1 indicates that the threshold used in the change amount comparison is “0.5”. The condition CD1 indicates that the firmness is to be altered to the firmness corresponding to the alteration details MINF1 when the condition is satisfied. In FIG. 7, the condition CD1 indicates that when there is a module in which the change amount in the pressure is the threshold “0.5” or more, the firmness of the module is to be altered to the firmness corresponding to the alteration details MINF1.

Note that the alteration condition information storage unit 124 may store various types of information according to a purpose, not limited to the above.

Although not illustrated in detail, the user information storage unit 125 according to the embodiment stores user information, being information related to the user. The user information storage unit 125 stores user information including various types of information used to identify the user and various types of information related to attributes of the user. In addition, the user information storage unit 125 stores personal identification information used for personal identification (specification) of the user. For example, the user information storage unit 125 stores a face image of the user used to identify the user. For example, the user information storage unit 125 stores attribute information such as age, sex, residence, place of employment, and interest of the user.

The user information storage unit 125 may store various types of information according to a purpose, not limited to the above.

Returning to FIG. 3, and description will continue. The control unit 130 is actualized by execution of programs stored in the information processing apparatus 100 (for example, information processing program such as a determination program according to the present disclosure) by a central processing unit (CPU), a micro processing unit (MPU), or the like, using RAM or the like, as a working area. In addition, the control unit 130 is a controller and is implemented by, for example, an integrated circuit such as an application specific integrated circuit (ASIC) or a field programmable gate array (FPGA).

As illustrated in FIG. 3, the control unit 130 includes an acquisition unit 131, an estimation unit 132, a determination unit 133, a processing unit 134, and a transmission unit 135, and implements or executes a function and an action of information processing described below. The internal configuration of the control unit 130 is not limited to the configuration illustrated in FIG. 3, and may be another configuration as long as it is a configuration that performs information processing described below. Furthermore, the connection relationship of the processing units included in the control unit 130 is not limited to the connection relationship illustrated in FIG. 3, and may be a different connection relationship.

The acquisition unit 131 acquires various types of information. The acquisition unit 131 acquires various types of information from an external information processing apparatus. The acquisition unit 131 acquires various types of information from the firmness alterable module 10. The acquisition unit 131 acquires various types of information from another information processing apparatus such as the sensor apparatus 50.

The acquisition unit 131 acquires various types of information from the storage unit 120. The acquisition unit 131 acquires various types of information from the module information storage unit 121, the history information storage unit 122, the sensor information storage unit 123, the alteration condition information storage unit 124, and the user information storage unit 125.

The acquisition unit 131 acquires various types of information estimated by the estimation unit 132. The acquisition unit 131 acquires various types of information determined by the determination unit 133. The acquisition unit 131 acquires various types of information processed by the processing unit 134.

The acquisition unit 131 acquires sensor information detected by the sensor. The acquisition unit 131 acquires sensor information including pressure information indicating the pressure applied to the surface of the target detected by the pressure sensor. The acquisition unit 131 acquires sensor information including pressure information indicating pressure applied to each of the plurality of regions on the surface of the target. The acquisition unit 131 acquires sensor information including image information captured by the image sensor. The acquisition unit 131 acquires sensor information including image information obtained by imaging the user by the image sensor.

For example, the acquisition unit 131 acquires, from the firmness alterable module 10, information indicating the pressure applied to the firmness alterable module 10 detected by a pressure sensor provided in the firmness alterable module 10. For example, the acquisition unit 131 acquires, from the sensor apparatus 50, image information captured by the sensor apparatus 50 being an image sensor.

The estimation unit 132 estimates various types of information. The estimation unit 132 estimates various types of information based on information from an external information processing apparatus or information stored in the storage unit 120. The estimation unit 132 estimates various types of information from the storage unit 120. The estimation unit 132 estimates various types of information from the module information storage unit 121, the history information storage unit 122, the sensor information storage unit 123, the alteration condition information storage unit 124, and the user information storage unit 125. The estimation unit 132 identifies various types of information. The estimation unit 132 estimates various types of information.

The estimation unit 132 extracts various types of information. The estimation unit 132 selects various types of information. The estimation unit 132 extracts various types of information based on information from an external information processing apparatus and information stored in the storage unit 120. The estimation unit 132 extracts various types of information from the storage unit 120. The estimation unit 132 extracts various types of information from the module information storage unit 121, the history information storage unit 122, the sensor information storage unit 123, the alteration condition information storage unit 124, and the user information storage unit 125.

The estimation unit 132 extracts various types of information based on the various types of information acquired by the acquisition unit 131. Furthermore, the estimation unit 132 extracts various types of information based on the various types of information determined by the determination unit 133. The estimation unit 132 extracts various types of information based on the information that has undergone execution by the processing unit 134.

Based on the sensor information acquired by the acquisition unit 131, the estimation unit 132 estimates a contact mode of an object with respect to the target in which the firmness of the surface is alterable. The estimation unit 132 estimates a contact mode of the object with the surface of the target based on the pressure information. The estimation unit 132 calculates a change amount in the pressure applied by the object to the surface of the target. Based on the pressure information, the estimation unit 132 calculates a change amount of the pressure applied by the object to each of the plurality of regions on the surface of the target.

Based on the image information, the estimation unit 132 estimates a contact mode of the object with the surface of the target. The estimation unit 132 calculates an intersection between a feature point of the object and the surface of the target by using a moving direction of the object based on the image information. The estimation unit 132 estimates the context related to the object based on the image information. The estimation unit 132 estimates information related to the user based on the image information. The estimation unit 132 estimates a contact mode of the object with respect to a plurality of regions on the surface of the target based on the image information.

The determination unit 133 determines various types of information. The determination unit 133 identifies various types of information. The determination unit 133 judges various types of information. For example, the determination unit 133 determines various types of information based on information from an external information processing apparatus or information stored in the storage unit 120. The determination unit 133 determines various types of information based on information from the firmness alterable module 10 and another information processing apparatus such as the sensor apparatus 50. The determination unit 133 determines various types of information based on information stored in the module information storage unit 121, the history information storage unit 122, the sensor information storage unit 123, the alteration condition information storage unit 124, or the user information storage unit 125.

The determination unit 133 determines various types of information based on the various types of information acquired by the acquisition unit 131. The determination unit 133 determines various types of information based on the various types of information estimated by the estimation unit 132. The determination unit 133 determines various types of information based on various types of information executed by the processing unit 134. The determination unit 133 alters various types of information based on the determination. Various types of information is updated based on the information acquired by the acquisition unit 131.

The determination unit 133 determines whether to alter the firmness of the surface of the target according to the contact mode of the object estimated by the estimation unit 132. The determination unit 133 determines whether to alter the firmness of the surface of the target based on the change amount in the pressure. In a case where the change amount in the pressure is a threshold or more, the determination unit 133 determines to alter the firmness of the surface of the target. In a case where a gesture corresponding to a pressure change pattern satisfies a condition, the determination unit 133 determines to alter the firmness of the surface of the target. The determination unit 133 determines the alteration amount of the firmness of the surface of the target according to the change amount in the pressure.

The determination unit 133 determines a region in which the change amount in the pressure satisfies the condition among the plurality of regions on the surface of the target, as the region to undergo firmness alteration. In a case where the distance between the feature point of the object and the intersection is the threshold or more, the determination unit 133 determines to alter the firmness of the surface of the target. The determination unit 133 determines the alteration amount of the firmness of the surface of the target according to the moving speed of the object.

In a case where the context estimated by the estimation unit 132 satisfies the condition, the determination unit 133 determines to alter the firmness of the surface of the target. The determination unit 133 determines the alteration amount in the firmness of the surface of the target according to the context. The determination unit 133 determines whether to alter the firmness of the surface of the target based on the information related to the user estimated by the estimation unit 132. The determination unit 133 determines a region in which the contact mode satisfies the condition among the plurality of regions on the surface of the target, as a region to undergo firmness alteration. The determination unit 133 determines a force used to press a flexible member 31 by a pressing mechanism 32.

The processing unit 134 executes various types of processing. The processing unit 134 executes various types of information based on information from an external information processing apparatus or information stored in the storage unit 120. The processing unit 134 executes various types of information based on information from the firmness alterable module 10 and another information processing apparatus such as the sensor apparatus 50. The processing unit 134 executes various types of information based on information stored in the module information storage unit 121, the history information storage unit 122, the sensor information storage unit 123, the alteration condition information storage unit 124, or the user information storage unit 125.

The processing unit 134 executes various types of information processing based on the various types of information acquired by the acquisition unit 131. The processing unit 134 executes various types of information based on the various types of information estimated by the estimation unit 132. The processing unit 134 executes various types of information based on the various types of information determined by the determination unit 133.

The processing unit 134 executes processing related to the alteration of the firmness of the firmness alterable module 10. The processing unit 134 executes processing of altering the firmness of the firmness alterable module 10 to the firmness determined by the determination unit 133. The processing unit 134 controls the firmness of the firmness alterable module 10 by instructing the transmission unit 135. The processing unit 134 instructs the transmission unit 135 to transmit information indicating firmness to the firmness alterable module 10. The processing unit 134 controls the force of pressing the flexible member 31 by the pressing mechanism 32 to execute processing of altering the firmness of the firmness alterable module 10.

The transmission unit 135 provides various types of information to an external information processing apparatus. The transmission unit 135 transmits various types of information to an external information processing apparatus. For example, the transmission unit 135 transmits various types of information to the firmness alterable module 10 and another information processing apparatus such as the sensor apparatus 50. The transmission unit 135 provides the information stored in the storage unit 120. The transmission unit 135 transmits the information stored in the storage unit 120.

The transmission unit 135 provides various types of information based on information from the firmness alterable module 10 and another information processing apparatus such as the sensor apparatus 50. The transmission unit 135 provides various types of information based on the information stored in the storage unit 120. The transmission unit 135 provides various types of information based on information stored in the module information storage unit 121, the history information storage unit 122, the sensor information storage unit 123, the alteration condition information storage unit 124, or the user information storage unit 125.

The transmission unit 135 transmits various types of information based on the various types of information acquired by the acquisition unit 131. The transmission unit 135 transmits various types of information based on the various types of information estimated by the estimation unit 132. The transmission unit 135 transmits various types of information based on the various types of information determined by the determination unit 133. The transmission unit 135 notifies various types of information based on various types of information executed by the processing unit 134. The transmission unit 135 transmits various types of information to the firmness alterable module 10 in response to an instruction from processing unit 134.

The transmission unit 135 transmits instruction information instructing the firmness alterable module 10 to alter the firmness to the firmness alterable module 10 in accordance with an instruction from the processing unit 134. The transmission unit 135 transmits instruction information instructing the firmness alterable module 10 to alter the firmness to the firmness alterable module 10 in accordance with an instruction from the processing unit 134. The transmission unit 135 transmits control information of controlling the firmness alterable module 10 to the firmness alterable module 10 in accordance with an instruction from the processing unit 134. The transmission unit 135 transmits, to the firmness alterable module 10, information designating a force used to press the flexible member 31 by the pressing mechanism 32.

### 1-4. Configuration of Firmness Alterable Module According to Embodiment

The following will describe a configuration of the firmness alterable module 10, which is an example of an output apparatus that executes output processing according to the embodiment. FIG. 8 is a diagram illustrating a configuration example of a firmness alterable module according to the embodiment of the present disclosure.

When pressure is detected, the firmness alterable module 10 may include a pressure sensor. For example, the firmness alterable module 10 includes a pressure sensor that detects a pressure applied to a surface 11 (an upper surface in FIG. 8). As long as the pressure applied to the surface 11 can be detected, a sensor (pressure sensor) that detects the pressure applied to the surface 11 may be provided outside the firmness alterable module 10.

As illustrated in FIG. 8, the firmness alterable module 10 includes a surface forming member 20, a softness/firmness controller 30, and a cover portion 40.

The surface forming member 20 has a structure for maintaining a surface shape. FIG. 8 illustrates a case where the surface forming member 20 has a structure that maintains a planar shape. However, the surface forming member 20 may have any structure as long as the surface shape is maintained. For example, the surface forming member 20 may have a structure that maintains a curved surface shape.

The surface forming member 20 includes a coupling portion 21 and a block portion 22. The coupling portion 21 is a sheet-like member that is flexible in a direction intersecting the surface 11. The coupling portion 21 is a sheet-like member disposed along the surface 11 and flexible in a direction intersecting the surface 11. The coupling portion 21 is formed of a material that permits bending but does not easily permit elongation. The coupling portion 21 is formed of a material having high flexibility and low elasticity. For example, the coupling portion 21 uses a plastic film, a nonwoven fabric, a nylon fabric, or the like.

The block portion 22 includes a plurality of blocks 220. The block portion 22 includes a plurality of blocks 220 aligned along a back surface which is a surface on a side opposite to the surface of the coupling portion 21 and coupled to the back surface.

The block 220 is desirably a rigid body that does not deform. For example, the block 220 may use rigid plastic, metal, wood, or the like. The block 220 has a first surface 221 and a second surface 222. Each of the plurality of blocks 220 is a hexahedron having the second surface 222, being an opposing surface facing the first surface 221, coupled to the coupling portion 21. Surfaces other than the first surface 221 and the second surface 222 are disposed adjacent to surfaces of the other blocks 220.

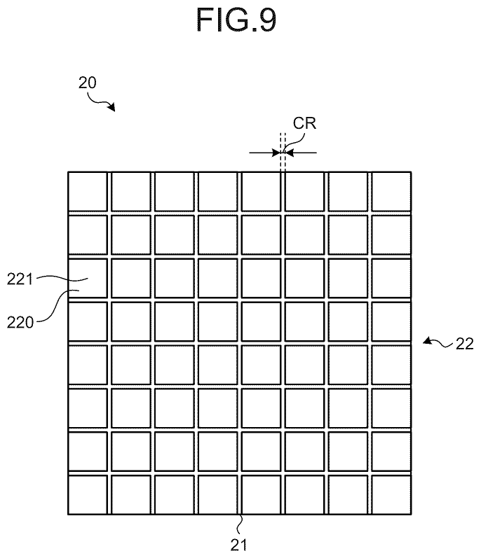

As illustrated in FIG. 9, the plurality of blocks 220 are disposed side by side over the back surface of the coupling portion 21. FIG. 9 is a plan view illustrating a main part of the firmness alterable module. FIG. 9 is a plan view of the surface forming member 20 from the back surface side of the coupling portion 21. In order to indicate that there is a clearance CR between the blocks 220, FIG. 9 explicitly illustrates a gap between the blocks 220. However, the clearance CR is desirably close to 0 mm. For example, the closer the clearance CR between the blocks 220 to 0 mm, the more the undesired deformation of the surface forming member 20 can be suppressed as compared with a case where the clearance CR is large.

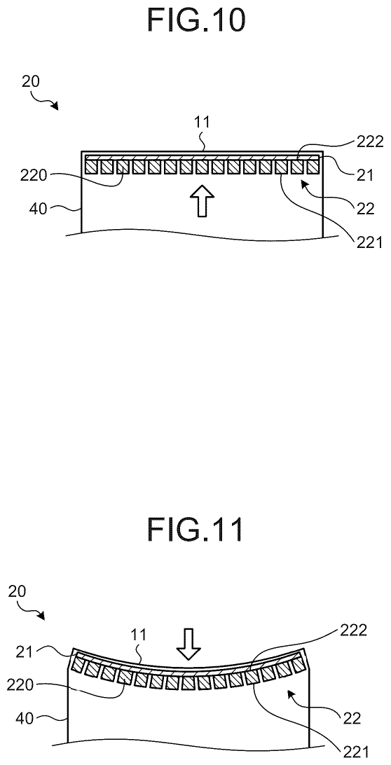

Here, an example of deformation of the surface forming member 20 when a force is applied to the surface forming member 20 will be described with reference to FIGS. 10 and 11. FIGS. 10 and 11 are side views illustrating main parts of the firmness alterable module.

Specifically, FIG. 10 illustrates a case where a force is applied from the block portion 22 side of the surface forming member 20, that is, from the inner side (softness/firmness controller 30 side) of the firmness alterable module 10. When a force is applied to the surface forming member 20 from the inner side of the firmness alterable module 10 in this manner, the blocks 220 interfere with each other to suppress deformation of the surface forming member 20. That is, when a force is applied to the surface forming member 20 from the inner side of the firmness alterable module 10, the shape of the surface 11 of the firmness alterable module 10 is maintained.

For example, in a case where the module does not include the surface forming member 20 which is a component for maintaining the surface shape of the surface, the upper surface of the module would protrude at the top at the time of compression. In contrast, by disposing the surface forming member 20 between the cover portion 40 and the flexible member 31, the firmness alterable module 10 is capable of maintaining the surface shape at the time of compression.

FIG. 11 illustrates a case where a force is applied from the coupling portion 21 side of the surface forming member 20, that is, from the outer side (surface 11 side) of the firmness alterable module 10. When a force is applied to the surface forming member 20 from the outer side of the firmness alterable module 10 in this manner, the surface forming member 20 easily deforms with no mutual interference of the blocks 220. That is, when a force is applied to the surface forming member 20 from the outer side of the firmness alterable module 10, the shape of the surface 11 of the firmness alterable module 10 is deformed.

The method of forming the surface forming member 20 can adopt any method. For example, the surface forming member 20 may be formed by adhesive forming. For example, the surface forming member 20 may be formed by forming the block portion 22 and then bonding the block portion 22 to the material of the coupling portion 21.

For example, the surface forming member 20 may be formed by integral forming. For example, the surface forming member 20 may be integrally formed with tough nylon. In this case, the coupling portion 21 and the block portion 22 may be formed using nylon. For example, the surface forming member 20 may be integrally formed by thickening the block portion 22 and thinning the coupling portion 21 as much as possible. The surface forming member 20 may be integrally formed by a multi-material 3D printer. In this case, it is allowable to use a rigid material for the block portion 22 and use a soft material for the coupling portion 21 and combine them to be integrally formed with each other. The above is merely an example, and the surface forming member 20 may be formed by any forming method as long as the block portion 22 having the plurality of blocks 220 is coupled to one surface (back surface) of the coupling portion 21.

The softness/firmness controller 30 has a function of altering firmness. The softness/firmness controller 30 is disposed along one surface of each of the plurality of blocks 220 with the block portion 22 interposed between the softness/firmness controller 30 and the coupling portion 21. The softness/firmness controller 30 includes the flexible member 31 and the pressing mechanism 32.

The flexible member 31 is a flexible material to be compressed. The flexible member 31 is formed with a flexible material. The flexible member 31 is desirably formed by using a material having elasticity and high shrinkability. For example, the flexible member 31 may be a flexible urethane foam, a spring, or the like.

The flexible member 31 is disposed along one surface of each of the plurality of blocks 220. For example, the flexible member 31 is disposed along the first surface 221 of each of the plurality of blocks 220 with the block portion 22 interposed between the flexible member 31 and the coupling portion 21. The flexible member 31 is compressed by being pressed toward the surface forming member 20 by the pressing mechanism 32.

The pressing mechanism 32 has a function of pressing the flexible member 31. The pressing mechanism 32 presses the flexible member 31 toward the block portion 22 from a position sandwiching the block portion 22 and the flexible member 31. The pressing mechanism 32 includes a movable portion 321, a drive unit 322, a shaft unit 323, and a support unit 324.

The movable portion 321 has a plate shape along the flexible member 31 at a position sandwiching the block portion 22 and the flexible member 31. The drive unit 322 moves the movable portion 321 in a direction intersecting the surface. The shaft unit 323 is attached to the movable portion 321 and transmits a force generated by the drive unit 322 to the movable portion 321. The support unit 324 functions as a support of the drive unit 322. For example, the support unit 324 supports the drive unit 322 and holds the position of the drive unit 322.

For example, the drive unit 322 includes a drive mechanism such as an actuator or a motor, and moves the shaft unit 323 forward and backward with respect to the flexible member 31 so as to move the movable portion 321 forward and backward with respect to the flexible member 31. With this configuration, the drive unit 322 alters the pressure on the flexible member 31 applied by the movable portion 321. The drive unit 322 is driven under the control of the information processing apparatus 100, and alters the pressing mode of the flexible member 31 to alter the firmness of the surface 11 of the firmness alterable module 10.

For example, when a linear motion motor having a screw lead of 1 millimeter (mm) and the number of steps of 200 is used for the drive unit 322, the firmness alterable module 10 operates as follows. Hereinafter, the frequency is assumed to be 1000 to 5000 pulses per second (pps).

For example, in the case of driving with 1000 pps, the drive unit 322 can be driven at 5 millimeter/second (mm/s), and can compress the flexible member 31 such as a piece of sponge by 60 mm at 15 second(s). Further, for example, in the case of driving with 5000 pps, the drive unit 322 can be driven at 25 mm/s, and can compress the flexible member 31 of the sponge by 60 mm at 2.4 seconds(s).

Although the above-described example has described an exemplary case where the softness/firmness controller 30 is constituted with the flexible member 31 and the pressing mechanism 32, the softness/firmness controller 30 can adopt any configuration as long as the firmness can be altered. For example, the softness/firmness controller 30 may be actualized by a powder. In this case, the softness/firmness controller 30 may be configured to be able to alter the firmness also by using jamming transition of the powder. For example, the softness/firmness controller 30 using the powder is softened by mixing the powder and air. In addition, for example, the softness/firmness controller 30 using the powder comes into a firm state by removing air in a state where the powder is pressed against the upper surface.

The cover portion 40 is a cover material that covers the firmness alterable module 10. The cover portion 40 is formed of a material having low elasticity. For example, the cover portion 40 is formed by using a material that is difficult to stretch, such as cloth or leather. The cover portion 40 may be a mesh (material). The cover portion 40 is disposed so as to cover the coupling portion 21, the block portion 22, and the softness/firmness controller 30. Another object such as a person comes into contact with the opposite surface (corresponding to the surface 11 in FIG. 8) of the surface of the cover portion 40 running along the coupling portion 21.

### [1-4-1. Configuration Example of Object Using Firmness Alterable Module]

The firmness alterable module 10 used for the object 2 provides an interface that alters the firmness of the surface of the object 2 with the above-described configuration. Note that any number of the firmness alterable modules 10 may be used for the object 2. For example, the object 2 may have a configuration in which one firmness alterable module 10 is used to alter the firmness of the entire surface of the object 2.

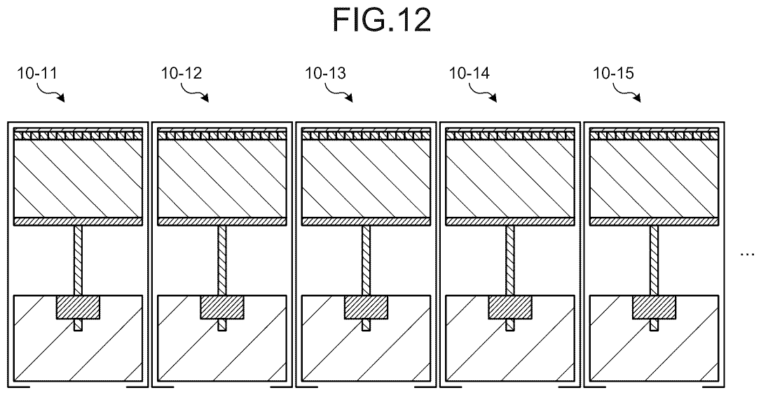

Furthermore, for example, the object 2 may be a mechanism in which the firmness of the surface of the object 2 is partially changed by arranging the firmness alterable modules 10 in an array. For example, as illustrated in FIG. 1, the object 2 may have a configuration in which a plurality of firmness alterable modules 10 are disposed side by side in a planar shape so as to partially alter the firmness of the surface of the object 2. FIG. 12 illustrates an example of arrangement of the plurality of firmness alterable modules 10.

FIG. 12 is a diagram illustrating an arrangement example of a plurality of firmness alterable modules. The diagram illustrates a state in which five firmness alterable modules 10-11 to 10-15 are disposed side by side. Although FIG. 12 illustrates only the five modules, the firmness alterable modules 10 more than five may be disposed side by side, or four or less of the firmness alterable modules 10 may be disposed side by side. For example, by arranging the firmness alterable modules 10, specifically each of the firmness alterable modules 10-11 to 10-15 illustrated in FIG. 12, side by side also in the depth direction of the page, a plurality of the firmness alterable modules 10 is to be disposed side by side in a planar shape as illustrated in FIG. 1.

### 1-5. Processing Example

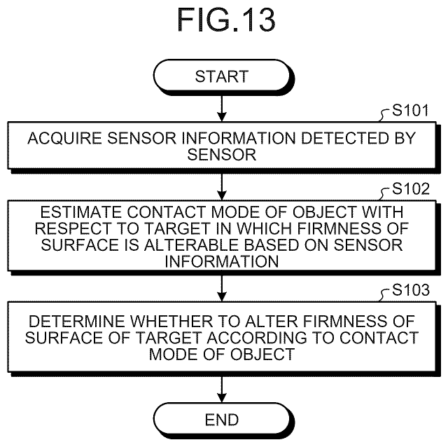

Hereinafter, specific examples of various types of processing will be described with reference to FIGS. 13 to 26. In the following description, description of points similar to the above-described contents will be appropriately omitted.

### [1-5-1. Information Processing Procedure According to Embodiment]

Next, an information processing procedure according to the embodiment will be described with reference to FIG. 13. FIG. 13 is a flowchart illustrating a procedure of information processing according to the embodiment of the present disclosure. Specifically, FIG. 13 is a flowchart illustrating a procedure of information processing performed by the information processing apparatus 100.

As illustrated in FIG. 13, the information processing apparatus 100 acquires sensor information detected by a sensor (step S101). For example, the information processing apparatus 100 acquires sensor information indicating a change in pressure corresponding to the firmness alterable module 10 detected by a pressure sensor provided in the firmness alterable module 10.

Based on the sensor information, the information processing apparatus 100 estimates a contact mode of an object with respect to a target in which the firmness of the surface is alterable (step S102). For example, the information processing apparatus 100 calculates the change amount in the pressure to the firmness alterable module 10 based on the change in pressure corresponding to the firmness alterable module 10.

Subsequently, the information processing apparatus 100 determines whether to alter the firmness of the surface of the target according to the contact mode of the object (step S103). In a case where the change amount in the pressure to the firmness alterable module 10 is a threshold or more, the information processing apparatus 100 determines to alter the firmness of the firmness alterable module 10.

### [1-5-2. Processing Example According to Pressure]

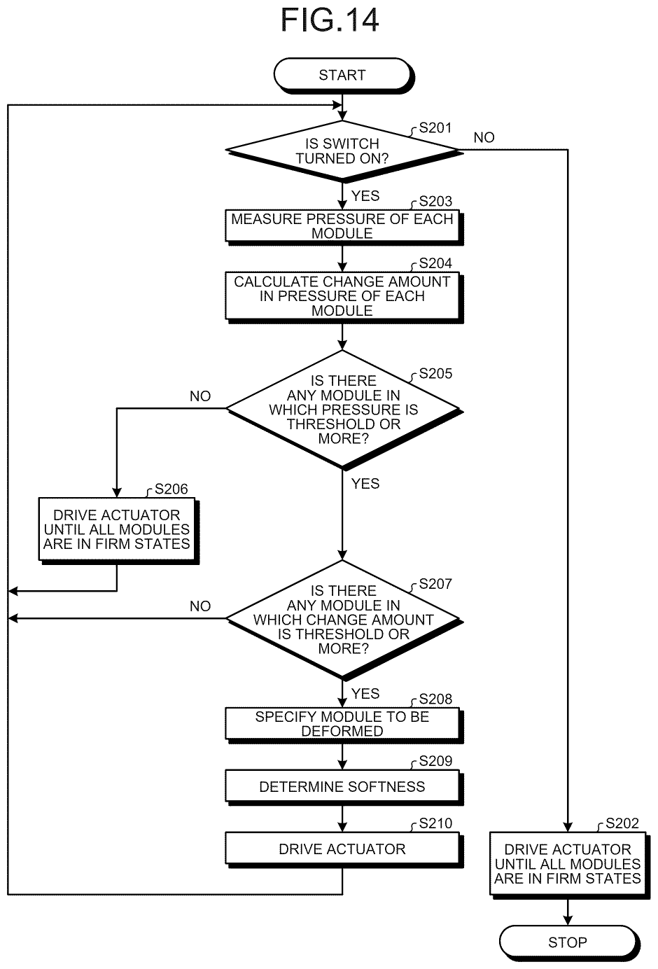

The outline of the information processing procedure by the information processing apparatus 100 has been described with FIG. 13. Hereinafter, specific examples will be described with reference to FIGS. 14 to 26. For example, the information processing apparatus 100 may alter the firmness of the module according to the change in pressure. For example, in a case where a certain weight (pressure) or more is detected for the object 2, the information processing apparatus 100 may alter the firmness of the firmness alterable module 10 of the object 2. For example, in a case where another object such as a coffee cup or a book is placed on the object 2, the information processing apparatus 100 may alter the firmness of the firmness alterable module 10 such that a position on the object 2 where the another object is placed becomes a firm surface like a side table. In contrast, regarding a position where a person sits, the information processing apparatus 100 may alter the firmness of the firmness alterable module 10 so that the position becomes a soft surface like a sofa.

The information processing system 1 performs sensing by pressure, and alters firmness of a surface of an object according to a sensing result. The information processing system 1 determines a deformation position. For example, the information processing system 1 determines a module to be deformed based on pressure distribution. The information processing system 1 determines firmness. For example, the information processing system 1 calculates the deformation amount from the pressure based on a preset deformation amount. The information processing system 1 alters firmness. For example, the information processing system 1 drives an actuator. In this manner, in the case of pressure sensing, the information processing system 1 determines the position to be deformed and the firmness of each module based on a timing at which the module and the object come into contact with each other, and drives each module.

Hereinafter, a specific example of interaction by pressure sensing will be described with reference to FIG. 14. FIG. 14 is a flowchart illustrating a procedure of processing according to pressure.

As illustrated in FIG. 14, in a case where the switch is not turned ON (step S201: No), the information processing apparatus 100 drives the actuator until all the modules are in firm states (step S202). For example, in a case where the switch for firmness alteration is OFF and the mode is not the firmness alteration mode, the information processing apparatus 100 controls the softness/firmness controller 30 until all the firmness alterable modules 10 of the object 2, which is the target, are in firm states. The information processing apparatus 100 maintains the state set in step S202 and stops firmness alteration.

The firm state herein may be the firmest state in a range alterable by the softness/firmness controller 30. Furthermore, although FIG. 14 is an exemplary case where the firm state is the initial setting state (default state), the default state is not limited to the firm state, and may be a soft (soft) state or an intermediate firmness state between the firm state and the soft state. The soft state here may be the softest state in the range alterable by the softness/firmness controller 30.

In a case where the switch is turned ON (step S201: Yes), the information processing apparatus 100 measures the pressure of each module (step S203). For example, in a case where the switch for firmness alteration is ON and the mode is the firmness alteration mode, the information processing apparatus 100 acquires information indicating the pressure of each of the firmness alterable modules 10 from the pressure sensor that detects the pressure of each of the firmness alterable modules 10.

Subsequently, the information processing apparatus 100 calculates a change amount in the pressure of each module (step S204). For example, the information processing apparatus 100 calculates the change amount of the pressure of each firmness alterable module 10 to estimate the contact mode with the object 2 equipped with the firmness alterable module 10.

Subsequently, the information processing apparatus 100 judges whether there is a module in which the pressure is a threshold or more (step S205). For example, the information processing apparatus 100 judges whether there is a firmness alterable module 10 in which the pressure is a threshold or more.

In a case where there is no module whose pressure is the threshold or more (step S205: No), the information processing apparatus 100 drives the actuator until all the modules are in firm states (step S206). For example, in a case where there is no firmness alterable module 10 in which the pressure is the threshold or more, the information processing apparatus 100 controls the softness/firmness controller 30 until all the firmness alterable modules 10 of the object 2 are in firm states. Subsequently, the information processing apparatus 100 returns to step S201 and repeats the processing.

In a case where there is a module in which the pressure is the threshold or more (step S205: Yes), the information processing apparatus 100 judges whether there is a module in which the change amount is the threshold or more (step S207). For example, the information processing apparatus 100 judges whether there is a firmness alterable module 10 in which the pressure change amount is a threshold or more.

In a case where there is no module in which the change amount is the threshold or more (step S207: No), the information processing apparatus 100 returns to step S201 and repeats the processing. For example, in a case where there is no firmness alterable module 10 in which the change amount in the pressure is the threshold or more, the information processing apparatus 100 returns to step S201 and repeats the processing without altering the firmness of the object 2.

In a case where there is a module in which the change amount is the threshold or more (step S207: Yes), the information processing apparatus 100 specifies a module to be deformed (step S208). For example, the information processing apparatus 100 determines the firmness alterable module 10 in which the pressure change amount is a threshold or more as a target module to undergo firmness alteration.

Subsequently, the information processing apparatus 100 determines softness (step S209). For example, the information processing apparatus 100 determines the softness of the firmness alterable module 10 determined as the target module. The information processing apparatus 100 determines to decrease the firmness of the firmness alterable module 10 such that the greater the pressure change amount, the more the firmness of the firmness alterable module 10 is to be decreased.

Subsequently, the information processing apparatus 100 drives the actuator (step S210). For example, the information processing apparatus 100 controls the softness/firmness controller 30 according to the determined firmness of the firmness alterable module 10. Subsequently, the information processing apparatus 100 returns to step S201 and repeats the processing.

As described above, in an interaction case using pressure sensing, the information processing apparatus 100 executes various types of processing according to ON and OFF states of the switch. For example, in a case where the switch is ON, the information processing apparatus 100 executes the following processing.

The information processing apparatus 100 measures the pressure of each module and calculates the change amount in the pressure. In a case where there is a module in which the pressure is the threshold or more and the change amount also exceeds the threshold, the information processing apparatus 100 sets the module as a target module to undergo deformation. The information processing apparatus 100 determines softness. In this case, the information processing apparatus 100 may set predetermined softness or may calculate softness with respect to pressure.

The information processing apparatus 100 drives the actuator to soften the module. Furthermore, in a case where a module that is already soft is excluded from the target, the information processing apparatus 100 may return the module to the firm state. In a case where there is no module in which the pressure is the threshold or more, the information processing apparatus 100 drives the actuator so set all the modules to firm states.

Furthermore, in a case where the switch is OFF, the information processing apparatus 100 drives the actuator to set all the modules to firm states. Furthermore, the information processing apparatus 100 may specify a target object using a camera or a tag and set a threshold according to the target object. In this case, the information processing apparatus 100 may lower the threshold of the pressure or the pressure change amount for a child, for example.

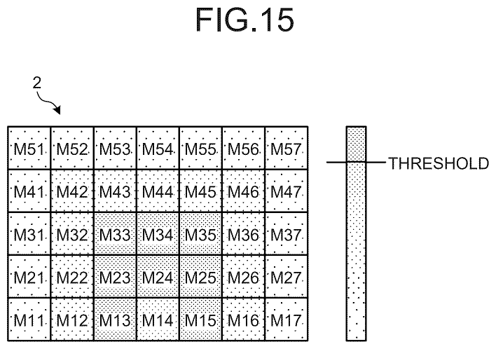

Note that the processing using the pressure described above is merely an example, and the information processing apparatus 100 may perform various types of processing using pressure information. For example, the information processing apparatus 100 may alter the firmness of the firmness alterable module 10 according to the pressure of another adjacent firmness alterable module 10. This point will be described with reference to FIG. 15. FIG. 15 is a diagram illustrating an example of alteration according to an adjacent module. FIG. 15 illustrates a pressure distribution diagram when the object 2 equipped with the firmness alterable module 10 is viewed from above. For example, the information processing apparatus 100 softens the firmness alterable module 10 in which the pressure is the threshold or more.

In FIG. 15, the darker the color of hatching, the larger the pressure value. For example, FIG. 15 illustrates a case where the pressures of eight modules, namely, modules M13, M15, M23 to M25, and M33 to M35 of the object 2 are equal to or more than the threshold as the condition for being the target module. Here, all the adjacent modules of the module M14, namely, the three modules M13, M15, and M24, have pressures equal to or more than the threshold of the condition for being the target module. Therefore, the information processing apparatus 100 also determines the module M14, being a module having three or more adjacent side modules with alteration, a target module to undergo firmness alteration. In this manner, the information processing apparatus 100 may set the module M14 to be a module to be deformed because the pressures of the three surrounding side modules are the threshold or above even though the pressure of the module M14 itself is the threshold or less.

Furthermore, the information processing apparatus 100 may alter the firmness of the module according to pressure change patterns. As an interaction case by pressure sensing, the information processing apparatus 100 may perform gesture recognition by a pressure change pattern and alter the firmness of the module according to the gesture. In this case, the information processing apparatus 100 may alter the firmness of the module when the gesture is detected.

For example, in a case where a gesture of pushing a surface of the object 2 is detected, the information processing apparatus 100 may soften, that is, decrease the firmness of a module corresponding to the surface. Furthermore, in a case where a gesture of pushing a soft surface of the object 2 is detected, the information processing apparatus 100 may increase the firmness of the module corresponding to the surface. Furthermore, the information processing apparatus 100 may learn a pressure pattern at the time of rising from the object 2 such as a cushion and increase the firmness of the module corresponding to the surface of the object 2 at the time of rising.

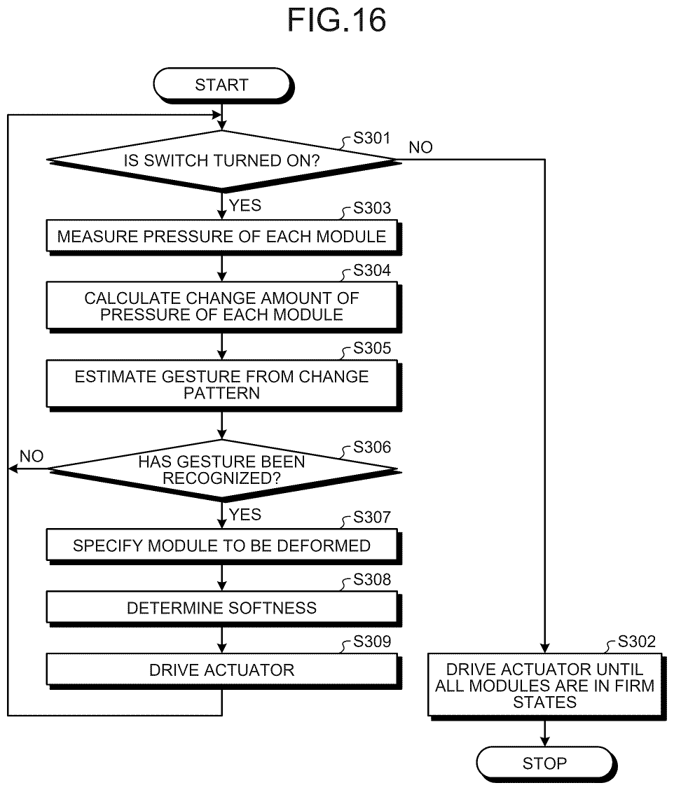

This point will be described with reference to FIG. 16. FIG. 16 is a flowchart illustrating a procedure of processing according to a pressure change pattern. Hereinafter, description of the points similar to the points described with FIG. 14 will be omitted as appropriate.

As illustrated in FIG. 16, in a case where the switch is not turned ON (step S301: No), the information processing apparatus 100 drives the actuator until all the modules are in firm states (step S302). The information processing apparatus 100 maintains the state set in step S302 and stops firmness alteration.

In a case where the switch is turned ON (step S301: Yes), the information processing apparatus 100 measures the pressure of each module (step S303). Subsequently, the information processing apparatus 100 calculates a change amount of the pressure of each module (step S304).

Subsequently, the information processing apparatus 100 estimates a gesture from the change pattern (step S305). For example, the information processing apparatus 100 estimates a gesture based on a pressure change pattern of each firmness alterable module 10 to estimate a contact mode with the object 2 equipped with the firmness alterable module 10.

Subsequently, the information processing apparatus 100 judges whether the gesture has been recognized (step S306). For example, the information processing apparatus 100 judges whether the pressure change pattern of each firmness alterable module 10 matches the change pattern corresponding to the gesture, thereby judging whether the gesture has been recognized. For example, in a case where the pattern of the change in pressure of each firmness alterable module 10 matches the change pattern corresponding to the gesture, the information processing apparatus 100 judges that the gesture has been recognized. For example, in a case where the pattern of the change in pressure of each firmness alterable module 10 does not match the change pattern corresponding to the gesture, the information processing apparatus 100 judges that the gesture has not been recognized.

In a case where the gesture has not been recognized (step S306: No), the information processing apparatus 100 returns to step S301 and repeats the processing.

In a case where the gesture has been recognized (step S306: Yes), the information processing apparatus 100 specifies a module to be deformed (step S307). For example, the information processing apparatus 100 determines the firmness alterable module 10 in which the pressure change amount is a threshold or more as a target module to undergo firmness alteration.

Subsequently, the information processing apparatus 100 determines softness (step S308). For example, the information processing apparatus 100 determines the softness of the firmness alterable module 10 determined as the target module. The information processing apparatus 100 determines to decrease the firmness of the firmness alterable module 10 such that the greater the pressure change amount, the more the firmness of the firmness alterable module 10 is to be decreased.

Subsequently, the information processing apparatus 100 drives the actuator (step S309). For example, the information processing apparatus 100 controls the softness/firmness controller 30 according to the determined firmness of the firmness alterable module 10. Subsequently, the information processing apparatus 100 returns to step S301 and repeats the processing.

### 1-5-3. Processing Example According to Object Detection

Furthermore, the information processing apparatus 100 may alter the firmness of the module using sensor information (image) detected by the camera.

The information processing system 1 performs sensing by a camera, and alters firmness of a surface of an object according to a sensing result. The information processing system 1 estimates a target object. For example, the information processing system 1 estimates a target object using object recognition. The information processing system 1 determines a deformation position. For example, the information processing system 1 determines a module to be deformed from the feature point and its displacement. The information processing system 1 determines firmness. For example, the information processing system 1 determines firmness based on a library of deformation amounts for a target object. For example, the information processing system 1 may calculate the deformation amount from the speed at the time of contact. Furthermore, for example, the information processing system 1 may calculate the deformation amount from the pressure. The information processing system 1 alters firmness. For example, the information processing system 1 drives an actuator. In this manner, in the case of sensing by the camera, the information processing system 1 can start interaction before the module and the object come into contact with each other. For example, the information processing system 1 can alter the firmness even before the module and the object come into contact with each other, can later the firmness according to the object or the context, and can estimate the speed at the time of contact.

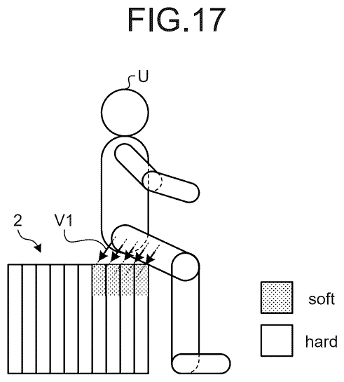

Hereinafter, an outline of an interaction case by camera sensing will be described with reference to FIG. 17. FIG. 17 is a conceptual diagram illustrating an example of alteration according to object detection. FIG. 17 illustrates a state in which a user U is about to sit on the object 2 which is a sofa. The information processing apparatus 100 extracts feature points of the user U using an image obtained by imaging the user U. The information processing apparatus 100 extracts the feature point of the user U appropriately using a certain technology, which may be any technology as long as the feature point of the object can be extracted by camera sensing, and detailed description will be omitted. Subsequently, the information processing apparatus 100 calculates a motion vector of the extracted feature point of the user U using the image obtained by imaging the user U. The information processing apparatus 100 calculates the motion vector of the feature point of the user U appropriately using a certain technology, which may be any technology as long as the motion vector of the feature point of the object can be calculated by camera sensing, and detailed description will be omitted.

In FIG. 17, the information processing apparatus 100 calculates a motion vector V1 of the feature point of the user U. Subsequently, the information processing apparatus 100 determines to soften, that is, decrease the firmness of the module in which a distance between an intersection on the module with the motion vectors from the feature point of the user U and the feature point is a predetermined value or less. For example, the information processing apparatus 100 determines an intersection on the surface of the object 2 with a motion vector from a feature point of the user U by using an image obtained by imaging the user U. Subsequently, the information processing apparatus 100 calculates a distance (also referred to as a “distance between intersections”) between each feature point of the user U and an intersection on the surface of the object 2 with the motion vector from each feature point by using the image obtained by imaging the user U. The information processing apparatus 100 determines to soften, that is, decrease the firmness of the module of the object 2, including the intersection where the distance between the intersections is a predetermined value or less. In FIG. 17, the information processing apparatus 100 determines to soften, that is, decrease the firmness of the hatched four modules from the right.

In this manner, the information processing apparatus 100 alters firmness when a target object such as the user U is detected. For example, in a case where a person tries to sit on the object 2, the information processing apparatus 100 alters the firmness of the module corresponding to the surface of the object 2 so that the surface becomes a soft surface like a sofa. Furthermore, in the case of an unstable object having a curved surface on the contact surface, the information processing apparatus 100 alters the firmness of the module corresponding to the surface of the object 2 so as to be a soft surface.

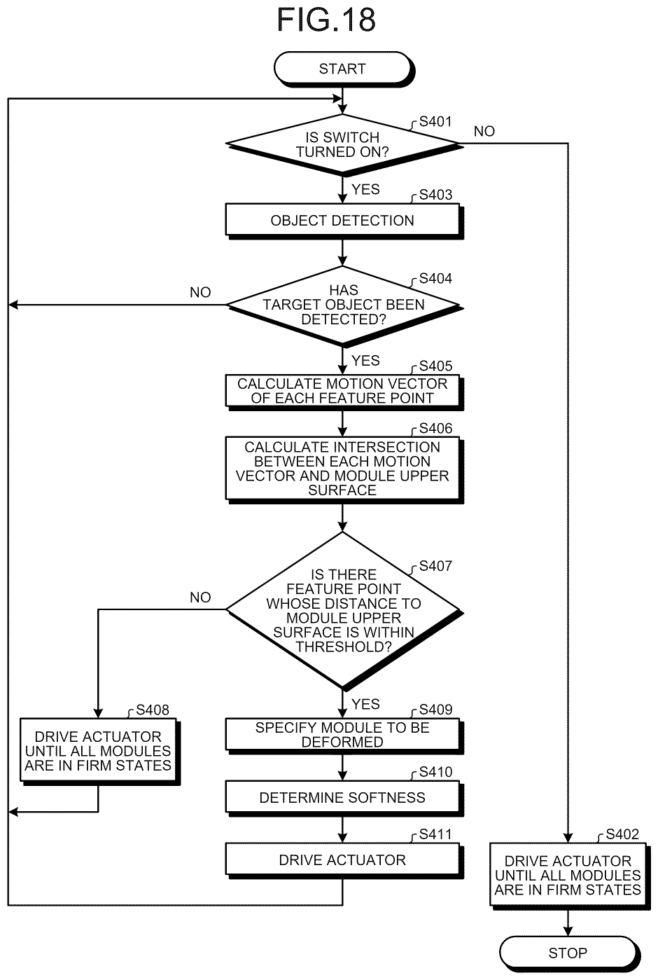

Hereinafter, an example of a flow of processing according to object detection will be described with reference to FIG. 18. FIG. 18 is a flowchart illustrating a procedure of processing according to object detection. Hereinafter, description of the points similar to the points described with FIG. 14, etc. will be omitted as appropriate.

As illustrated in FIG. 18, in a case where the switch is not turned ON (step S401: No), the information processing apparatus 100 drives the actuator until all the modules are in firm states (step S402). The information processing apparatus 100 maintains the state set in step S402 and stops firmness alteration.

In a case where the switch is ON (step S401: Yes), the information processing apparatus 100 perform object detection (step S403). The information processing apparatus 100 appropriately performs object detection using a certain technology, which may be any technology as long as object detection can be performed using an image, and detailed description thereof will be omitted. For example, in a case where the switch for firmness alteration is ON and the mode is the firmness alteration mode, the information processing apparatus 100 performs object detection using an image captured by the sensor apparatus 50 being a camera.

Subsequently, the information processing apparatus 100 judges whether a target object has been detected (step S404). In a case where the target object has not been detected (step S404: No), the information processing apparatus 100 returns to step S401 and repeats the processing.

When a target object is detected (step S404: Yes), the information processing apparatus 100 calculates a motion vector of each feature point (step S405). For example, in a case where a target object is detected, the information processing apparatus 100 extracts a feature point of the target object and calculates a motion vector of each extracted feature point.

Subsequently, the information processing apparatus 100 calculates an intersection between each motion vector and the module upper surface (step S406). For example, the information processing apparatus 100 calculates the intersection of the motion vector from the feature point of the target object with the upper surface of the module of the object 2.

The information processing apparatus 100 judges whether there is a feature point whose distance to the module upper surface is within a threshold (step S407). For example, the information processing apparatus 100 judges whether there is a feature point whose distance from the feature point of the target object to the intersection on the upper surface of the module of the object 2 corresponding to the feature point is within the threshold.

In a case where there is no feature point whose distance to the module upper surface is within the threshold (step S407: No), the information processing apparatus 100 drives the actuator until all the modules are in firm states (step S408). For example, in a case where there is no feature point whose distance from the feature point of the target object to the intersection on the upper surface of the module of the object 2 corresponding to the feature point is within the threshold, the information processing apparatus 100 controls the softness/firmness controller 30 until all the firmness alterable modules 10 of the object 2 are in firm states. Subsequently, the information processing apparatus 100 returns to step S401 and repeats the processing.

In a case where there is a feature point whose distance to the module upper surface is within the threshold (step S407: Yes), the information processing apparatus 100 specifies a module to be deformed (step S409). For example, the information processing apparatus 100 determines the firmness alterable module 10 including an intersection whose distance from the feature point of the target object is within a threshold as a target module to undergo firmness alteration.

Subsequently, the information processing apparatus 100 determines softness (step S410). For example, the information processing apparatus 100 determines the softness of the firmness alterable module 10 determined as the target module. The information processing apparatus 100 determines to decrease the firmness of the firmness alterable module 10 such that the higher the moving speed of the target object, the more the firmness of the firmness alterable module 10 being a target module is to be decreased.

Subsequently, the information processing apparatus 100 drives the actuator (step S411). For example, the information processing apparatus 100 controls the softness/firmness controller 30 according to the determined firmness of the firmness alterable module 10. Subsequently, the information processing apparatus 100 returns to step S401 and repeats the processing.

As described above, in an interaction case using camera sensing, the information processing apparatus 100 executes various types of processing according to ON and OFF states of the switch. For example, in a case where the switch is ON, the information processing apparatus 100 executes the following processing.

The information processing apparatus 100 performs object estimation. In a case where an object being a target is detected, the information processing apparatus 100 calculates a motion vector of each feature point of the object. For example, when having detected a target object such as a person or an object having a curved surface for which the module is to be softened, the information processing apparatus 100 calculates a motion vector of each feature point of the object.

The information processing apparatus 100 calculates an intersection between the motion vector and the module upper surface. In a case where there is a feature point whose distance to the module upper surface is within a threshold, the information processing apparatus 100 defines a module including an intersection of a motion vector of the feature point and the module upper surface, as a target module to undergo deformation. The information processing apparatus 100 determines softness. The information processing apparatus 100 may prepare a library of softness for the target object in advance and refer to the value. In a case where a pressure sensor is included in the module, the information processing apparatus 100 may calculate softness with respect to pressure.

The information processing apparatus 100 may alter the softness in consideration of the moving speed of the feature point. When the module to be deformed is determined, the information processing apparatus 100 may drive the actuator to set the module in a soft state. Furthermore, in a case where a module that is already soft is excluded from the target, the information processing apparatus 100 may return the module to the firm state. In a case where there is no feature point whose distance to the module upper surface is within the threshold, the information processing apparatus 100 may drive the actuator so that all the modules are in firm states.

Furthermore, in a case where the switch is OFF, the information processing apparatus 100 drives the actuator to set all the modules to firm states.

### [1-5-4. Processing Example According to Context]

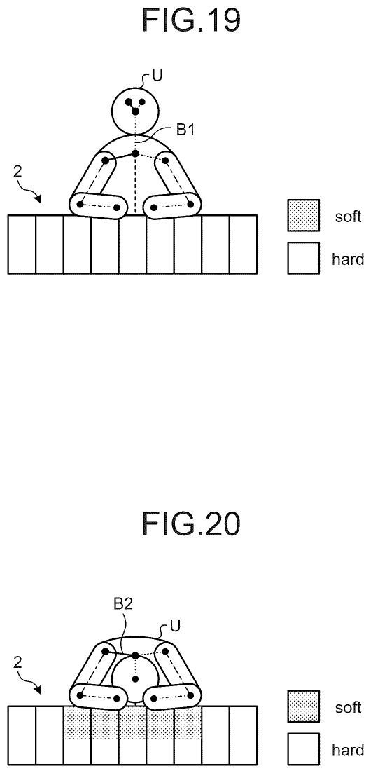

The information processing apparatus 100 may alter the firmness of the module according to the context. First, an outline of an interaction case according to a context will be described with reference to FIGS. 19 and 20. FIG. 19 is a conceptual diagram illustrating an example of alteration according to a context. FIG. 20 is a conceptual diagram illustrating an example of alteration according to a context.

FIG. 19 illustrates a state in which a user U is in a working state and brings their arms into contact with the object 2 being a desk. In addition, FIG. 20 illustrates a state in which the user U is in a state of facing down on the desk, that is, in a state in which the user U sleeps, with their arms being in contact with the object 2 being a desk. Using an image obtained by imaging the user U, the information processing apparatus 100 estimates an intended use of the object 2 by the user U as a context. In a case where the image in which the user U is in the state of FIG. 19 is acquired, the information processing apparatus 100 estimates that the object 2, being a desk, is a context used for work based on bone information detected by bone detection as illustrated in a bone B1 of the user U. In another case where the image in which the user U is in the state of FIG. 20 is acquired, the information processing apparatus 100 estimates that the object 2, being a desk, is a context used for rest based on bone information detected by bone detection as illustrated in a bone B2 of the user U.

For example, after a target context has been detected, the information processing apparatus 100 alters firmness. For example, as illustrated in FIG. 19, the information processing apparatus 100 alters the firmness of the module such that the entire surface of the object 2 will be a firm surface like a desk when the user U works. Furthermore, for example, in a case where the user U tries to sleep facing down as illustrated in FIG. 20, the information processing apparatus 100 alters the firmness of the module so that the surface with which the user U comes in contact becomes a soft surface. In FIG. 20, the information processing apparatus 100 determines to soften, that is, decrease the firmness of the five hatched central modules. Furthermore, in a case where the user U tries to rest elbows, the information processing apparatus 100 may alter the firmness of the module so that a portion where the elbow of the user U touches becomes a soft surface.

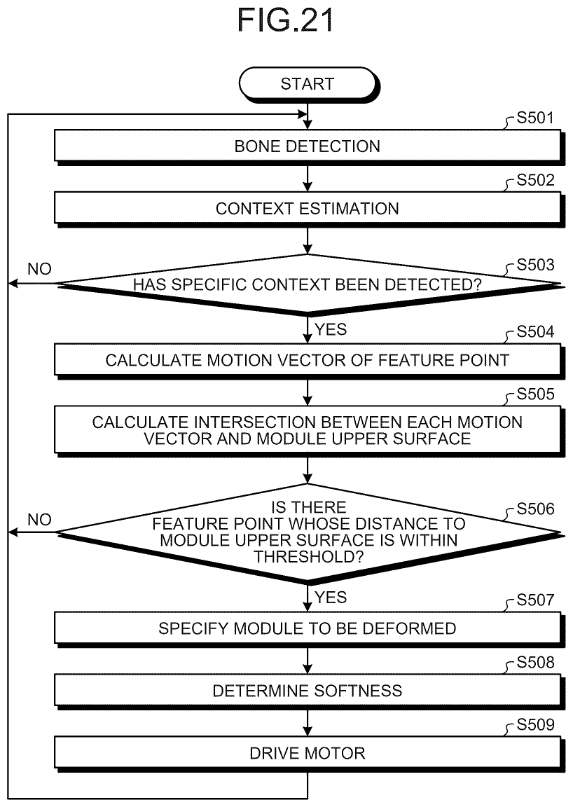

Hereinafter, an example of a flow of processing according to the context will be described with reference to FIG. 21. FIG. 21 is a flowchart illustrating a procedure of processing according to a context. Note that description of points similar to the description in FIGS. 14, 18, and the like will be omitted as appropriate.

As illustrated in FIG. 21, the information processing apparatus 100 performs bone detection (step S501). The information processing apparatus 100 appropriately performs bone detection using a certain technology, which may be any technology as long as bone detection can be performed using an image, and a detailed description thereof will be omitted. Subsequently, the information processing apparatus 100 performs context estimation using bone information indicating a detection result of the bone detection (step S502). The information processing apparatus 100 appropriately performs context estimation using a certain technology, which may be any technology as long as context estimation can be performed using the detection result of bone detection, and detailed description will be omitted.

Subsequently, the information processing apparatus 100 judges whether a specific context has been detected (step S503). In a case where the specific context has not been detected (step S503: No), the information processing apparatus 100 returns to step S501 and repeats the processing.

In a case where the specific context has been detected (step S503: Yes), the information processing apparatus 100 calculates a motion vector of the feature point (step S504). Subsequently, the information processing apparatus 100 calculates an intersection between each motion vector and the module upper surface (step S505).

The information processing apparatus 100 judges whether there is a feature point whose distance to the module upper surface is within a threshold (step S506). In a case where there is no feature point whose distance to the module upper surface is within the threshold (step S506: No), the information processing apparatus 100 returns to step S501 and repeats the processing. In a case where there is a feature point whose distance to the module upper surface is within the threshold (step S506: Yes), the information processing apparatus 100 specifies a module to be deformed (step S507).

Subsequently, the information processing apparatus 100 determines softness (step S508). The information processing apparatus 100 drives the motor (step S509). For example, the information processing apparatus 100 controls the softness/firmness controller 30 according to the determined firmness of the firmness alterable module 10. Subsequently, the information processing apparatus 100 returns to step S501 and repeats the processing.

As described above, the information processing apparatus 100 executes firmness control by context based on sensing by a camera.

The information processing apparatus 100 performs bone detection. The information processing apparatus 100 estimates the context from the bone information. In a case where a specific context has been detected, the information processing apparatus 100 calculates a motion vector of each feature point of the object. For example, in an exemplary case of a desk, the information processing apparatus 100 calculates a motion vector of each feature point of the object in a case where a specific context such as resting an elbow or facing down has been detected.

The information processing apparatus 100 calculates an intersection between the motion vector and the module upper surface. In a case where there is a feature point whose distance to the module upper surface is within a threshold, the information processing apparatus 100 defines a module including an intersection of a motion vector of the feature point and the module upper surface, as a target module to undergo deformation. The information processing apparatus 100 determines softness. The information processing apparatus 100 may prepare a library of softness for the target object in advance and refer to the value. In a case where a pressure sensor is included in the module, the information processing apparatus 100 may calculate softness with respect to pressure.

The information processing apparatus 100 may alter the softness in consideration of the moving speed of the feature point. When the module to be deformed is determined, the information processing apparatus 100 may drive the motor to set the module in a soft state. In a case where a module that is already soft is excluded from the target, the information processing apparatus 100 may return the module to the firm state. In a case where there is no feature point whose distance to the module upper surface is within the threshold, the information processing apparatus 100 may drive the motor so that all the modules are in firm states.

### 1-5-5. Processing Example According to User

The information processing apparatus 100 may alter the firmness of the module according to the user. For example, the information processing apparatus 100 may individually identify the user of the object 2 and alter the firmness of the object 2 to firmness according to the user. For example, the information processing apparatus 100 may alter the firmness of the object 2 such as a car seat, an office chair, or a bed to personalized firmness.

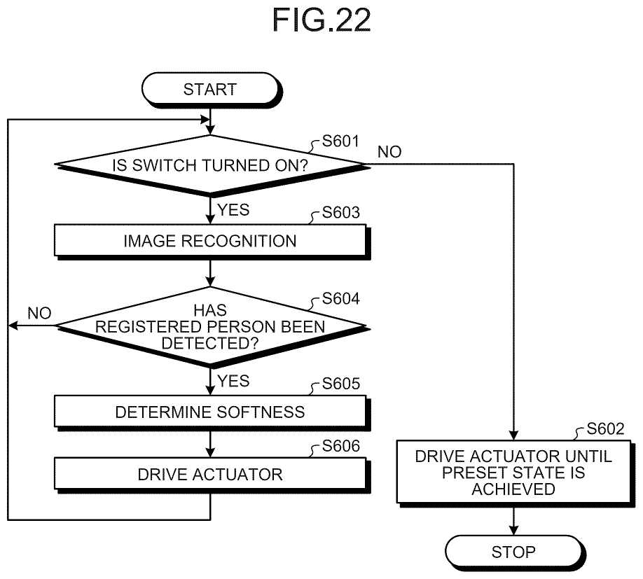

First, an example of a flow of processing according to a user will be described with reference to FIG. 22. FIG. 22 is a flowchart illustrating a procedure of processing according to object detection. Note that description of points similar to the description in FIGS. 14, 18, and the like will be omitted as appropriate.

As illustrated in FIG. 22, in a case where the switch is not turned ON (step S601: No), the information processing apparatus 100 drives the actuator until a preset state is achieved (step S602). For example, in a case where the switch for firmness alteration is OFF and the mode is not the firmness alteration mode, the information processing apparatus 100 controls the softness/firmness controller 30 until all the firmness alterable modules 10 of the object 2 as the target object are in preset states (default state). Subsequently, the information processing apparatus 100 maintains the state set in step S602 and stops firmness alteration.

When the switch is turned ON (step S601: Yes), the information processing apparatus 100 performs image recognition (step S603). The information processing apparatus 100 appropriately performs image recognition using a certain technology, which may be any technology as long as image recognition for specifying the user can be performed, and a detailed description thereof will be omitted. For example, in a case where the switch for firmness alteration is ON and the mode is the firmness alteration mode, the information processing apparatus 100 performs image recognition using an image captured by the sensor apparatus 50 being a camera.

Subsequently, the information processing apparatus 100 judges whether a registered person has been detected (step S604). In a case where the registered person has not been detected (step S604: No), the information processing apparatus 100 returns to step S601 and repeats the processing.

In a case where the registered person has been detected (step S604: Yes), the information processing apparatus 100 determines softness (step S605). For example, in a case where the registered person has been detected, the information processing apparatus 100 acquires setting information of the firmness of the object 2 corresponding to the person from the storage unit 120, and determines the firmness of each of the firmness alterable modules 10 using the acquired setting information of the firmness of the object 2.

Subsequently, the information processing apparatus 100 drives the actuator (step S606). For example, the information processing apparatus 100 controls the softness/firmness controller 30 according to the determined firmness of the firmness alterable module 10. Subsequently, the information processing apparatus 100 returns to step S601 and repeats the processing.

As described above, in an interaction case corresponding to the user, the information processing apparatus 100 executes various types of processing according to ON and OFF of the switch. For example, the information processing apparatus 100 performs image recognition in a case where the switch is ON. Subsequently, in a case where the registered person is detected, the information processing apparatus 100 acquires softness (deformation amount) information of each module from the library, and drives the actuator using the acquired information.

In a case where the switch is OFF, the information processing apparatus 100 drives the actuator so as to set all the modules in preset states. Furthermore, the information processing apparatus 100 recognizes (specifies) the user included in the image by using a certain personal identification method. The information processing apparatus 100 may use not only image recognition but also information of a tag, a smartphone, and biological information. Furthermore, the information processing apparatus 100 may use personalized firmness (deformation amount) information. For example, the information processing apparatus 100 may use preregistered information. For example, the information processing apparatus 100 may update the information by acquiring habits of the user at the time of use from the pressure distribution or the posture information by the camera and performing machine learning using the data of habits.

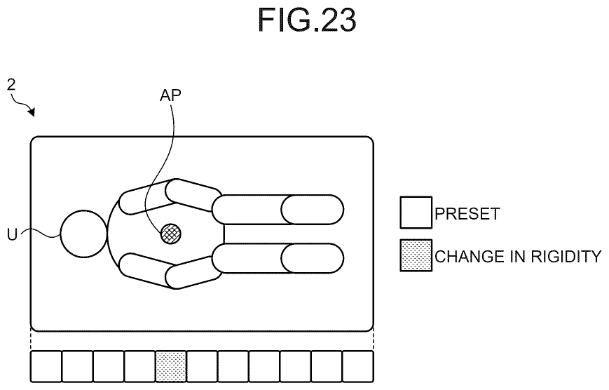

Note that the above-described change in firmness according to the user is merely an example, and the information processing apparatus 100 may alter the firmness by appropriately using various information related to the user. For example, in a case where there is a part that should not be pressed due to injury or the like, the information processing apparatus 100 may alter the firmness distribution of the surface of the object 2 being a bed so as not to apply pressure to the affected part. First, an outline of an interaction case according to a physical part of the user will be described with reference to FIG. 23. FIG. 23 is a conceptual diagram illustrating an example of alteration according to a physical part of the user.

FIG. 23 illustrates a state in which a user U having a physical part AP in the abdomen as an affected part is lying on the object 2 being a bed. The information processing apparatus 100 specifies the position on the object 2 where the physical part AP of the user U is located by using the image obtained by imaging the object 2 being bed on which the user U is lying and the physical part AP of the user U. Subsequently, the information processing apparatus 100 determines to soften, that is, decrease the firmness of the module disposed at the position on the object 2 where the physical part AP of the user U is located. In FIG. 23, the information processing apparatus 100 determines to soften, that is, decrease the firmness of the hatched module, being the fourth module from the left.

In this manner, in a case where there is an affected part such as the case of the user U, the information processing apparatus 100 alters the firmness of the position on the object 2 corresponding to the affected part of the user U. For example, in a case where a person with an affected part is lying on the object 2, the information processing apparatus 100 alters the firmness of the module corresponding to the surface of the object 2 so that a place where the affected part is located becomes a soft surface.

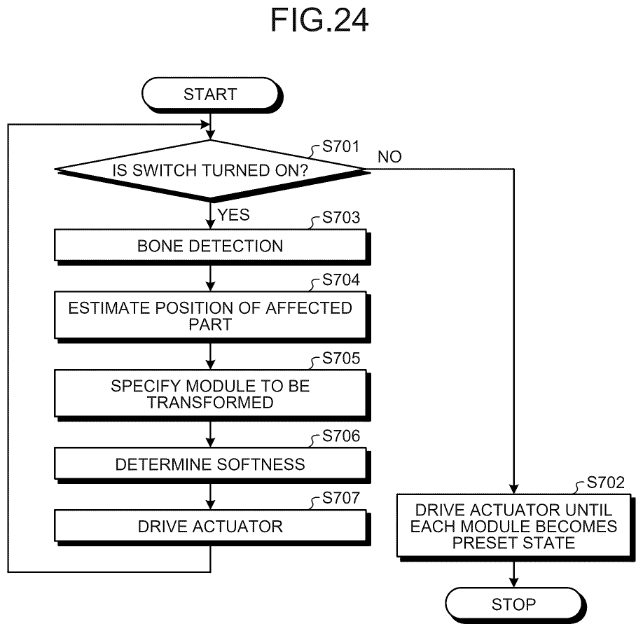

Hereinafter, an example of a flow of processing according to the physical part of the user will be described with reference to FIG. 24. FIG. 24 is a flowchart illustrating a procedure of processing according to a physical part of a user. Note that description of points similar to the description in FIGS. 14, 21, 22, and the like will be omitted as appropriate.

As illustrated in FIG. 24, in a case where the switch is not turned ON (step S701: No), the information processing apparatus 100 drives the actuator until each module becomes a preset state (step S702). For example, in a case where the switch for firmness alteration is OFF and the mode is not the firmness alteration mode, the information processing apparatus 100 controls the softness/firmness controller 30 until all the firmness alterable modules 10 of the object 2 as the target object are in preset states (default state). Subsequently, the information processing apparatus 100 maintains the state set in step S702 and stops firmness alteration.

In a case where the switch is ON (step S701: Yes), the information processing apparatus 100 performs bone detection (step S703). Subsequently, the information processing apparatus 100 estimates the position of the affected part using the bone information indicating the detection result of the bone detection (step S704). The information processing apparatus 100 appropriately performs position estimation of the affected part using a certain technology, which may be any technology as long as position estimation of the affected part can be performed using the detection result of bone detection, and detailed description will be omitted.

Subsequently, the information processing apparatus 100 specifies a module to be transformed (step S705). For example, the information processing apparatus 100 determines the firmness alterable module 10 corresponding to position of the affected part in the object 2 as a target module to undergo firmness alteration.

Subsequently, the information processing apparatus 100 determines softness (step S706). For example, the information processing apparatus 100 determines the softness of the firmness alterable module 10 determined as the target module. For example, the information processing apparatus 100 determines to decrease the firmness of the firmness alterable module 10 such that the larger the affected part position, the more the firmness of the firmness alterable module 10 is to be decreased.

Subsequently, the information processing apparatus 100 drives the actuator (step S707). For example, the information processing apparatus 100 controls the softness/firmness controller 30 according to the determined firmness of the firmness alterable module 10. Subsequently, the information processing apparatus 100 returns to step S701 and repeats the processing.

As described above, in an interaction case corresponding to the physical part of the user, the information processing apparatus 100 executes various types of processing according to ON and OFF of the switch. For example, in a case where the switch is ON, the information processing apparatus 100 executes the following processing.

The information processing apparatus 100 performs object estimation. The information processing apparatus 100 detects a bone. The information processing apparatus 100 estimates the affected part position on the bone based on information of the affected part position and the bone information. Based on the affected part position information, the information processing apparatus 100 sets a module near the affected part position as a target module to undergo deformation. The information processing apparatus 100 determines softness. The information processing apparatus 100 may use firmness (deformation amount) set in advance. When the module to be deformed is determined, the information processing apparatus 100 may drive the actuator to set the module in a soft state. Furthermore, in a case where a module that is already soft is excluded from the target, the information processing apparatus 100 may return the module to the preset state.

In a case where the switch is OFF, the information processing apparatus 100 drives the actuator so as to set all the modules in preset states.

### [1-5-6. Processing Example According to Force Applied to User]

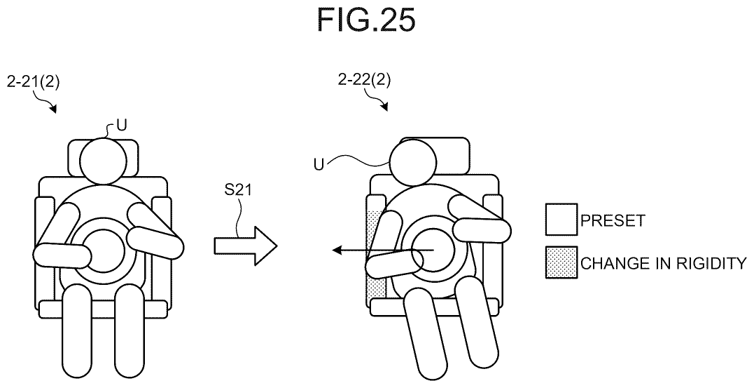

Furthermore, the information processing apparatus 100 may alter the firmness of the module according to the force applied to the user. For example, the information processing apparatus 100 may dynamically alter the firmness according to the change in inertia accompanying movement. For example, the information processing apparatus 100 alters the firmness of a part of a seat, which is an example of the object 2 and is normally soft, so as to support the body of the user when the body of the user is pressed against the seat due to an inertial force when turning a curve on a road. First, an outline of another interaction case by sensing according to the force applied to the user will be described with reference to FIG. 25. FIG. 25 is a conceptual diagram illustrating an example of alteration according to a force applied to a user.

FIG. 25 illustrates a state in which a user U is driving while sitting on an object 2 being a seat of an automobile. In FIG. 25, the object 2 before the firmness alteration is described as an “object 2-21”, and the object 2 after the firmness alteration is described as an “object 2-22”. However, the object 2 will be described as the object 2 when described with no particular distinction from each other. The object 2-21 indicates a state in which the lateral force applied to the user U is less than a predetermined value. In addition, the object 2-22 indicates a state in which the lateral force applied to the user U is a predetermined value or more.

In a case where the lateral force applied to the user U is the predetermined value or more, the information processing apparatus 100 determines to alter the firmness of the module (step S21). In a case where the lateral force applied to the user U alters from the state indicated by the object 2-21 to the state indicated by the object 2-22, the information processing apparatus 100 determines to alter the firmness of the module located in the moving direction of the body of the user U. In FIG. 25, the information processing apparatus 100 determines to alter the firmness of the module of the hatched portion on the right side of the seat. In this case, the firmness of the module of the hatched portion may be increased or decreased on the right side of the seat of the object 2. For example, the information processing apparatus 100 may determine to increase the firmness to make the module firm in the hatched portion on the right side of the seat. For example, the information processing apparatus 100 may determine to soften, that is, decrease the firmness of the module in the hatched portion on the right side of the seat.

In this manner, the information processing apparatus 100 alters the firmness when the force applied to the user U satisfies a predetermined condition. As described above, the information processing apparatus 100 alters the firmness of the module in a case where the inertial force has greatly changed.

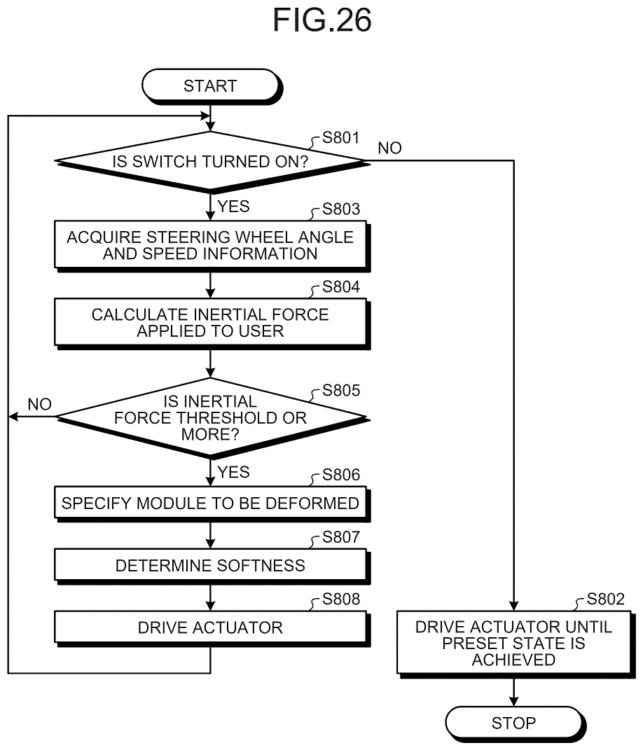

Hereinafter, an example of a flow of processing according to object detection will be described with reference to FIG. 26. FIG. 26 is a flowchart illustrating a procedure of processing according to a force applied to a user. Note that description of points similar to the description in FIGS. 14, 18, 22, and the like will be omitted as appropriate.

As illustrated in FIG. 26, in a case where the switch is not turned ON (step S801: No), the information processing apparatus 100 drives the actuator until the preset state is achieved (step S802). Subsequently, the information processing apparatus 100 maintains the state set in step S802 and stops firmness alteration.

When the switch is turned ON (step S801: Yes), the information processing apparatus 100 acquires the steering wheel angle and speed information (step S803). The information processing apparatus 100 acquires information indicating the angle of the steering wheel and speed information indicating the speed detected by the sensor apparatus 50 such as an accuracy sensor and a speed sensor. For example, in a case where the switch for firmness alteration is ON and the mode is the firmness alteration mode, the information processing apparatus 100 acquires steering wheel angle information and speed information detected by the sensor apparatus 50.

Subsequently, the information processing apparatus 100 calculates an inertial force applied to the user (step S804). For example, the information processing apparatus 100 calculates the inertial force applied to the user by using the steering wheel angle information and the speed information.

The information processing apparatus 100 judges whether the inertial force is a threshold or more (step S805). For example, the information processing apparatus 100 judges whether the inertial force applied to the user is the threshold or more.

In a case where the inertial force is not the threshold or more (step S805: No), the information processing apparatus 100 returns to step S801 and repeats the processing. That is, in a case where the inertial force applied to the user is less than the threshold, the information processing apparatus 100 returns to step S801 and repeats the processing without altering the firmness.

In a case where the inertial force is the threshold or more (step S805: Yes), the information processing apparatus 100 specifies a module to be deformed (step S806). For example, in a case where the inertial force is the threshold or more, the information processing apparatus 100 determines the firmness alterable module 10 located in an acting direction of the inertial force among the objects 2 as a target module to undergo firmness alteration.

Subsequently, the information processing apparatus 100 determines softness (step S807). For example, the information processing apparatus 100 determines the softness of the firmness alterable module 10 determined as the target module. The information processing apparatus 100 determines to decrease the firmness of the firmness alterable module 10 such that the greater the inertial force on the user, the more the firmness of the firmness alterable module 10 being a target module is to be decreased.

Subsequently, the information processing apparatus 100 drives the actuator (step S808). For example, the information processing apparatus 100 controls the softness/firmness controller 30 according to the determined firmness of the firmness alterable module 10. Subsequently, the information processing apparatus 100 returns to step S801 and repeats the processing.

As described above, in an interaction case using camera sensing, the information processing apparatus 100 executes various types of processing according to ON and OFF states of the switch. For example, in a case where the switch is ON, the information processing apparatus 100 executes the following processing.

The information processing apparatus 100 acquires steering wheel angle, speed information, and the like. The information processing apparatus 100 calculates an inertial force applied to the user based on the acquired information. In a case where the inertial force is a threshold or more, the information processing apparatus 100 specifies a module to be deformed based on the direction of the inertial force. The information processing apparatus 100 determines softness. The information processing apparatus 100 may perform calculation based on the current (pre-change) firmness and the value of the inertial force. The information processing apparatus 100 drives an actuator.

In a case where the switch is OFF, the information processing apparatus 100 drives the actuator so as to set all the modules in preset states.

### [1-5-7. Other Information Examples]

Note that the above-described processing is merely an example, and the information processing apparatus 100 may perform processing by appropriately using various types of information. For example, the information processing apparatus 100 may perform an interaction using information detected by various sensors, not limited to the pressure sensor or the camera, as an implicit input.

For example, the information processing apparatus 100 may use biological information of the user. For example, the information processing apparatus 100 may use information related to respiration of the user. For example, the information processing apparatus 100 may alter the firmness of the object 2 for the purpose of relaxation so as to control the breathing rhythm of the user with the object 2, which is a cushion that expands or contracts, as a target object. For example, the information processing apparatus 100 may alter the firmness of the object 2 so as to bring about a relaxation effect on the user by controlling the respiration of the user by alternately switching the partial softness/firmness of the backrest of the object 2.

For example, the information processing apparatus 100 may use the electroencephalogram of the user. For example, the information processing apparatus 100 may predict the action of the user from the electroencephalogram pattern to alter the firmness of the object 2 being the target object.

For example, the information processing apparatus 100 may use verbal input by the user. For example, the information processing apparatus 100 may alter the firmness of the object 2 such that, when a voice command of the user is recognized by the voice recognition technology, the firmness is altered to the instructed firmness.

For example, the information processing apparatus 100 may use information regarding a change in the external environment. For example, in a case where an earthquake occurs, the information processing apparatus 100 may judge whether another object (such as a vase) being a fragile object is placed on the object 2 from the information obtained by object recognition. When having judged that another object being a fragile object is placed on the object 2, the information processing apparatus 100 may alter the firmness of the object 2 so as to decrease the firmness of the periphery of the position of the object 2 on which the other object is placed in order to prevent breakage even if the object 2 falls down.

### 2. OTHER EMBODIMENTS

The process according to each of embodiments described above may be performed in various different forms (modifications) in addition to each of embodiments or modifications described above.

### 2-1. Other Configuration Examples

Although the above information processing system 1 has been described using the example in which the information processing apparatus 100 is disposed in the object 2. However, the above configuration is an example, and as long as a service related to the firmness alteration of the surface of the object 2 can be provided, the information processing system 1 can arrange the apparatus in any manner. For example, the information processing system 1 may have a configuration in which the information processing apparatus 100 is located outside the object 2, and the information processing apparatus 100 communicates with the firmness alterable module 10 located in the object 2, so as to allow the information processing apparatus 100 to control the firmness of the firmness alterable module 10.

### 2-2. Others

Furthermore, among each processing described in the above embodiments, all or a part of the processing described as being performed automatically can be manually performed, or the processing described as being performed manually can be performed automatically by a known method. In addition, the processing procedures, specific names, and information including various data and parameters depicted in the above specifications or drawings can be altered in any manner unless otherwise specified. For example, various types of information illustrated in each of the drawings are not limited to the information illustrated.

In addition, each of components of each device is provided as a functional and conceptional illustration and thus does not necessarily need to be physically configured as illustrated. That is, the specific form of distribution/integration of each device is not limited to those depicted in the drawings, and all or a part thereof may be functionally or physically distributed or integrated into arbitrary units according to various loads and use conditions.

Furthermore, the above-described embodiments and modifications can be appropriately combined within a range implementable without contradiction of processing.

The effects described in the present specification are merely examples, and thus, there may be other effects, not limited to the exemplified effects.

### 3. EFFECTS ACCORDING TO PRESENT DISCLOSURE

As described above, the information processing apparatus (the information processing apparatus 100 in the embodiment) according to the present disclosure includes the acquisition unit (the acquisition unit 131 in the embodiment), the estimation unit (the estimation unit 132 in the embodiment), and the determination unit (the determination unit 133 in the embodiment). The acquisition unit acquires sensor information detected by the sensor. Based on the sensor information acquired by the acquisition unit, the estimation unit estimates a contact mode of an object with respect to the target whose surface firmness is alterable. The determination unit determines whether to alter the firmness of the surface of the target according to the contact mode of the object estimated by the estimation unit.

In this manner, by determining whether to alter the firmness of the surface of the target according to the contact mode of the object with respect to the target object estimated based on the sensor information detected by the sensor, the information processing apparatus according to the present disclosure can alter the firmness of the surface of the target with no explicit instruction from the user. Consequently, the information processing apparatus can appropriately alter the firmness of the surface of the object.

The acquisition unit acquires sensor information including pressure information indicating the pressure on the surface of the target detected by the pressure sensor. The estimation unit estimates a contact mode of the object with the surface of the target based on the pressure information. In this manner, by determining whether to alter the firmness of the surface of the target according to the pressure to the surface of the target, the information processing apparatus according to the present disclosure can alter the firmness of the surface of the target with no explicit instruction from the user. Consequently, the information processing apparatus can appropriately alter the firmness of the surface of the object.

The estimation unit calculates a change amount in the pressure applied by the object to the surface of the target. The determination unit determines whether to alter the firmness of the surface of the target based on the change amount in the pressure. In this manner, by determining whether to alter the firmness of the surface of the target according to the change amount of pressure to the surface of the target, the information processing apparatus according to the present disclosure can alter the firmness of the surface of the target with no explicit instruction from the user. Consequently, the information processing apparatus can appropriately alter the firmness of the surface of the object.

In a case where the change amount in the pressure is a threshold or more, the determination unit determines to alter the firmness of the surface of the target. In this manner, by determining to alter the firmness of the surface of the target when the change amount of pressure to the surface of the target is a threshold or more, the information processing apparatus according to the present disclosure can alter the firmness of the surface of the target with no explicit instruction from the user. Consequently, the information processing apparatus can appropriately alter the firmness of the surface of the object.

In a case where a gesture corresponding to a pressure change pattern satisfies a condition, the determination unit determines to alter the firmness of the surface of the target. In this manner, by determining to alter the firmness of the surface of the target in the case where the gesture corresponding to the pressure change pattern satisfies the condition, the information processing apparatus according to the present disclosure can alter the firmness of the surface of the target with no explicit instruction from the user. Consequently, the information processing apparatus can appropriately alter the firmness of the surface of the object.

The determination unit determines the alteration amount in the firmness of the surface of the target according to the change amount in the pressure. In this manner, by determining the alteration amount in the firmness of the surface of the target according to the change amount of pressure, the information processing apparatus according to the present disclosure can alter the firmness of the surface of the target with no explicit instruction from the user. Consequently, the information processing apparatus can appropriately alter the firmness of the surface of the object.

The acquisition unit acquires sensor information including pressure information indicating pressure to each of the plurality of regions on the surface of the target. Based on the pressure information, the estimation unit calculates a change amount of the pressure applied by the object to each of the plurality of regions on the surface of the target. The determination unit determines a region in which the change amount in the pressure satisfies the condition among the plurality of regions on the surface of the target, as the region to undergo firmness alteration. In this manner, by determining the region where the change amount in the pressure satisfies the condition among the plurality of regions on the surface of the target, as a region to undergo firmness alteration, the information processing apparatus can alter the partial firmness of the surface of the target. Consequently, the information processing apparatus can appropriately alter the firmness of the surface of the object.

The acquisition unit acquires sensor information including image information captured by the image sensor. Based on the image information, the estimation unit estimates a contact mode of the object with the surface of the target. In this manner, by estimating a contact mode of the object with the surface of the target based on the image information and determining whether to alter the firmness of the surface of the target according to the estimated contact mode of the object with the target object, the information processing apparatus according to the present disclosure can alter the firmness of the surface of the target with no explicit instruction from the user. Consequently, the information processing apparatus can appropriately alter the firmness of the surface of the object.

The estimation unit calculates an intersection between a feature point of the object and the surface of the target by using a moving direction of the object based on the image information. In a case where the distance between the feature point of the object and the intersection is the threshold or more, the determination unit determines to alter the firmness of the surface of the target. In this manner, by determining to alter the firmness of the surface of the target when the distance between the feature point of the object and the intersection is a threshold or more, the information processing apparatus according to the present disclosure can alter the firmness of the surface of the target with no explicit instruction from the user. Consequently, the information processing apparatus can appropriately alter the firmness of the surface of the object.

The determination unit determines the alteration amount in the firmness of the surface of the target according to the moving speed of the object. In this manner, by determining the alteration amount in the firmness of the surface of the target according to the moving speed of the object, the information processing apparatus according to the present disclosure can alter the firmness of the surface of the target with no explicit instruction from the user. Consequently, the information processing apparatus can appropriately alter the firmness of the surface of the object.

Furthermore, the estimation unit estimates the context related to the object based on the image information. When the context estimated by the estimation unit satisfies a condition, the determination unit determines to alter the firmness of the surface of the target. In this manner, by determining to alter the firmness of the surface of the target when the estimated context satisfies the condition, the information processing apparatus according to the present disclosure can alter the firmness of the surface of the target with no explicit instruction from the user. Consequently, the information processing apparatus can appropriately alter the firmness of the surface of the object.

The determination unit determines the alteration amount in the firmness of the surface of the target according to the context. In this manner, by determining the alteration amount in the firmness of the surface of the target according to the context, the information processing apparatus according to the present disclosure can alter the firmness of the surface of the target with no explicit instruction from the user. Consequently, the information processing apparatus can appropriately alter the firmness of the surface of the object.

The acquisition unit acquires sensor information including image information obtained by imaging the user by the image sensor. The estimation unit estimates information related to the user based on the image information. The determination unit determines whether to alter the firmness of the surface of the target based on the information related to the user estimated by the estimation unit. In this manner, by determining whether to alter the firmness of the surface of the target based on the information related to the user which is estimated based on the image information including the image of the user, the information processing apparatus according to the present disclosure can alter the firmness of the surface of the target with no explicit instruction from the user. Consequently, the information processing apparatus can appropriately alter the firmness of the surface of the object.

The estimation unit estimates a contact mode of the object with respect to a plurality of regions on the surface of the target based on the image information. The determination unit determines a region in which the contact mode satisfies the condition among the plurality of regions on the surface of the target, as a region to undergo firmness alteration. In this manner, by determining the region in which the contact mode satisfies the condition among the plurality of regions on the surface of the target, as a region to undergo firmness alteration, the information processing apparatus can alter the partial firmness of the surface of the target. Consequently, the information processing apparatus can appropriately alter the firmness of the surface of the object.

As described above, the firmness alterable module (the firmness alterable module 10 in the embodiment) according to the present disclosure is a firmness alterable module constituting at least a part of a surface of a target, and includes a coupling portion (the coupling portion 21 in the embodiment), a block portion (the block portion 22 in the embodiment), and a softness/firmness controller (the softness/firmness controller 30 in the embodiment). The coupling portion is a sheet-like member disposed along the surface and flexible in a direction intersecting the surface. The block portion includes a plurality of blocks (the blocks 220 in the embodiment) aligned along a back surface which is a surface on a side opposite to the surface of the coupling portion and coupled to the back surface. The softness/firmness controller is disposed along one surface of each of the plurality of blocks with the block portion interposed between the softness/firmness controller and the coupling portion, and can alter firmness.

In this manner, the firmness alterable module according to the present disclosure includes: the sheet-like coupling portion disposed along the surface and flexible in the direction intersecting the surface; and the plurality of blocks disposed side by side along the back surface on the opposite side of the surface of the coupling portion and coupled to the back surface, making it possible to suppress the change in the shape of the surface due to the pressure toward the surface side. Consequently, the information processing apparatus can appropriately alter the firmness of the surface of the object.

In addition, each of the plurality of blocks is a hexahedron in which a facing surface facing one surface is coupled to the coupling portion, while surfaces other than the one surface and the facing surface are disposed adjacent to surfaces of other blocks. In this manner, the firmness alterable module has each of the plurality of blocks disposed adjacent to each other. This allows the blocks to interfere with each other when the pressure to the surface side is generated, making it possible to suppress the change in the shape of the surface due to the pressure to the surface side. Consequently, the information processing apparatus can appropriately alter the firmness of the surface of the object.

In addition, the softness/firmness controller includes a flexible member (the flexible member 31 in the embodiment) and a pressing mechanism (the pressing mechanism 32 in the embodiment). The flexible member is disposed along one surface of each of the plurality of blocks. The pressing mechanism presses the flexible member toward the block portion from a position where the block portion and the flexible member are sandwiched. In this manner, since the firmness alterable module has the flexible member, the firmness of the surface of the target can be altered by pressing the flexible member. Consequently, the information processing apparatus can appropriately alter the firmness of the surface of the object.

In addition, the pressing mechanism includes a movable portion (the movable portion 321 in the embodiment) and a drive unit (the drive unit 322 in the embodiment). The movable portion has a plate shape along the flexible member at a position sandwiching the block portion and the flexible member. The drive unit moves the movable portion in a direction intersecting the surface. In this manner, the firmness alterable module can change the firmness of the surface of the target by pressing the flexible member with the plate-shaped movable portion. Consequently, the information processing apparatus can appropriately alter the firmness of the surface of the object.

In addition, the firmness alterable module includes a cover portion (the cover portion 40 in the embodiment). The cover portion covers the coupling portion, the block portion, and the softness/firmness controller, and an object comes in contact with a surface opposite to a surface along the coupling portion. In this manner, the firmness alterable module has a member that covers the outer surface of the firmness alterable module and comes into contact with an external object, making it possible to appropriately hold the shape of the surface. Consequently, the information processing apparatus can appropriately alter the firmness of the surface of the object.

### 4. HARDWARE CONFIGURATION

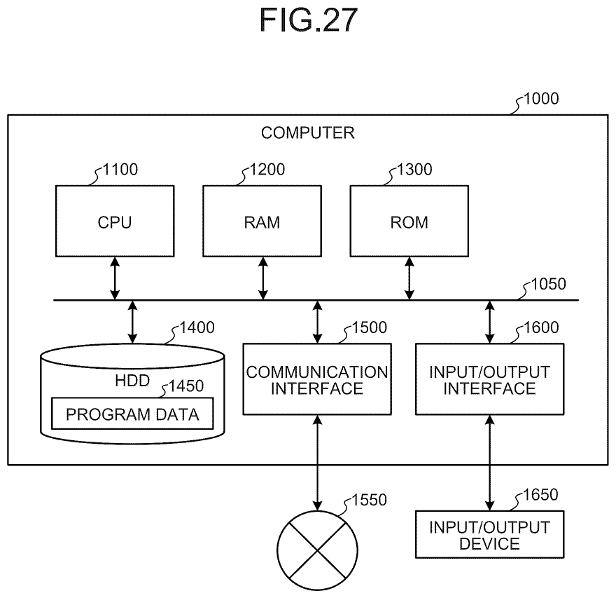

The information apparatus such as the information processing apparatus 100 according to the above-described individual embodiments and modifications are implemented by a computer 1000 having a configuration as illustrated in FIG. 27, for example. FIG. 27 is a hardware configuration diagram illustrating an example of the computer 1000 that implements the functions of the information processing apparatus such as the information processing apparatus 100. Hereinafter, the information processing apparatus 100 according to the embodiment will be described as an example. The computer 1000 includes a CPU 1100, RAM 1200, read only memory (ROM) 1300, a hard disk drive (HDD) 1400, a communication interface 1500, and an input/output interface 1600. Individual components of the computer 1000 are interconnected by a bus 1050.

The CPU 1100 operates based on a program stored in the ROM 1300 or the HDD 1400 so as to control each of components. For example, the CPU 1100 develops the program stored in the ROM 1300 or the HDD 1400 into the RAM 1200 and executes processing corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that records a program executed by the CPU 1100, data used by the program, or the like. Specifically, the HDD 1400 is a recording medium that records an information processing program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting an input/output device 1650 with the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on predetermined recording medium (or simply medium). Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory.

For example, when the computer 1000 functions as the information processing apparatus 100 according to the embodiment, the CPU 1100 of the computer 1000 executes the information processing program loaded on the RAM 1200 so as to implement the functions of the control unit 130 and the like. Furthermore, the HDD 1400 stores the information processing program according to the present disclosure or data in the storage unit 120. While the CPU 1100 executes program data 1450 read from the HDD 1400, the CPU 1100 may acquire these programs from another device via the external network 1550, as another example.

Note that the present technology can also have the following configurations.

(1)

An information processing apparatus comprising:
an acquisition unit that acquires sensor information detected by a sensor;
an estimation unit that estimates, based on the sensor information acquired by the acquisition unit, a contact mode of an object with respect to a target of which a firmness of a surface is alterable; and
a determination unit that determines whether to alter the firmness of the surface of the target according to the contact mode of the object estimated by the estimation unit.
   (2)

The information processing apparatus according to (1), wherein
the acquisition unit
acquires the sensor information including pressure information indicating a pressure applied to the surface of the target detected by a pressure sensor, and
the estimation unit
estimates the contact mode of the object with the surface of the target based on the pressure information.
   (3)

The information processing apparatus according to (2), wherein
the estimation unit
calculates a change amount in the pressure applied by the object to the surface of the target, and
the determination unit
determines whether to alter the firmness of the surface of the target based on the change amount in the pressure.
   (4)

The information processing apparatus according to (3), wherein
the determination unit
determines to alter the firmness of the surface of the target in a case where the change amount in the pressure is a threshold or more.
   (5)

The information processing apparatus according to (3), wherein
the determination unit
determines to alter the firmness of the surface of the target in a case where a gesture corresponding to a pressure change pattern satisfies a condition.
   (6)

The information processing apparatus according to any one of (3) to (5), wherein
the determination unit
determines an alteration amount in the firmness of the surface of the target according to the change amount in the pressure.
   (7)

The information processing apparatus according to any one of (3) to (6), wherein
the acquisition unit
acquires the sensor information including the pressure information indicating a pressure to each of a plurality of regions on the surface of the target,
the estimation unit
calculates, based on the pressure information, the change amount in the pressure applied by the object to each of the plurality of regions on the surface of the target, and
the determination unit
determines a region in which the change amount in the pressure satisfies a condition, among the plurality of regions on the surface of the target, as a region to undergo firmness alteration.
   (8)

The information processing apparatus according to any one of (1) to (7), wherein
the acquisition unit
acquires the sensor information including image information imaged by an image sensor, and
the estimation unit
estimates the contact mode of the object with the surface of the target based on the image information.
   (9)

The information processing apparatus according to (8), wherein
the estimation unit
calculates an intersection between a feature point of the object and the surface of the target by using a moving direction of the object based on the image information, and
the determination unit
determines to alter the firmness of the surface of the target in a case where a distance between the feature point of the object and the intersection is a threshold or more.
   (10)

The information processing apparatus according to (9), wherein
the determination unit
determines an alteration amount in the firmness of the surface of the target according to a moving speed of the object.
   (11)

The information processing apparatus according to (9) or (10), wherein
the estimation unit
estimates a context related to the object based on the image information, and
the determination unit
determines to alter the firmness of the surface of the target in a case where the context estimated by the estimation unit satisfies a condition.
   (12)

The information processing apparatus according to (11), wherein
the determination unit
determines an alteration amount in the firmness of the surface of the target according to the context.
   (13)

The information processing apparatus according to any one of (8) to (12), wherein
the acquisition unit
acquires the sensor information including the image information obtained by imaging a user by the image sensor,
the estimation unit
estimates information related to the user based on the image information, and
the determination unit
determines whether to alter the firmness of the surface of the target based on the information related to the user estimated by the estimation unit.
   (14)

The information processing apparatus according to any one of (8) to (13), wherein
the estimation unit
estimates the contact mode of the object with respect to a plurality of regions on the surface of the target based on the image information, and
the determination unit
determines a region in which the contact mode satisfies a condition among the plurality of regions on the surface of the target, as a region to undergo firmness alteration.
   (15)

An information processing method comprising:
acquiring sensor information detected by a sensor;
estimating, based on the acquired sensor information, a contact mode of an object with respect to a target of which a firmness of a surface is alterable; and
determining whether to alter the firmness of the surface of the target according to the estimated contact mode of the object.
   (16)

A firmness alterable module constituting at least a part of a surface of a target, the firmness alterable module comprising:
a sheet-like coupling portion that is disposed along the surface and is flexible in a direction intersecting the surface;
a block portion having a plurality of blocks disposed side by side along a back surface and coupled to the back surface, the back surface being a surface opposite to the surface of the coupling portion; and
a softness/firmness controller that is disposed along one surface of each of the plurality of blocks with the block portion interposed between the softness/firmness controller and the coupling portion, the softness/firmness controller being capable of altering firmness.
   (17)

The firmness alterable module according to (16), wherein
each of the plurality of blocks is
a hexahedron in which a facing surface facing the one surface is coupled to the coupling portion, and surfaces other than the one surface and the facing surface are disposed adjacent to surfaces of other blocks.
   (18)

The firmness alterable module according to (16) or (17), wherein
the softness/firmness controller includes:
a flexible member disposed along one surface of each of the plurality of blocks; and
a pressing mechanism that presses the flexible member toward the block portion from a position where the block portion and the flexible member are sandwiched.
   (19)

The firmness alterable module according to (18), wherein
the pressing mechanism includes:
a movable portion having a plate shape along the flexible member at a position sandwiching the block portion and the flexible member; and
a drive unit that moves the movable portion in a direction intersecting the surface.
   (20)

The firmness alterable module according to any one of (16) to (19), further comprising
a cover portion that covers the coupling portion, the block portion, and the softness/firmness controller, and to which an object comes in contact with a surface being an opposite surface of a surface running along the coupling portion.

### REFERENCE SIGNS LIST

1 INFORMATION PROCESSING SYSTEM
100 INFORMATION PROCESSING APPARATUS
110 COMMUNICATION UNIT
120 STORAGE UNIT
121 MODULE INFORMATION STORAGE UNIT
122 HISTORY INFORMATION STORAGE UNIT
123 SENSOR INFORMATION STORAGE UNIT
124 ALTERATION CONDITION INFORMATION STORAGE UNIT
125 USER INFORMATION STORAGE UNIT
130 CONTROL UNIT
131 ACQUISITION UNIT
132 ESTIMATION UNIT
133 DETERMINATION UNIT
134 PROCESSING UNIT
135 TRANSMISSION UNIT
10 FIRMNESS ALTERABLE MODULE
20 SURFACE FORMING MEMBER
21 COUPLING PORTION
22 BLOCK PORTION
220 BLOCK
221 FIRST SURFACE
222 SECOND SURFACE
30 SOFTNESS/FIRMNESS CONTROLLER
31 FLEXIBLE MEMBER
32 PRESSING MECHANISM
321 MOVABLE PORTION
322 DRIVE UNIT
323 SHAFT UNIT
324 SUPPORT UNIT
40 COVER PORTION
50 SENSOR APPARATUS

1. An information processing apparatus comprising:
an acquisition unit that acquires sensor information detected by a sensor;
an estimation unit that estimates, based on the sensor information acquired by the acquisition unit, a contact mode of an object with respect to a target of which a firmness of a surface is alterable; and
a determination unit that determines whether to alter the firmness of the surface of the target according to the contact mode of the object estimated by the estimation unit.

2. The information processing apparatus according to claim 1, wherein
the acquisition unit
acquires the sensor information including pressure information indicating a pressure applied to the surface of the target detected by a pressure sensor, and
the estimation unit
estimates the contact mode of the object with the surface of the target based on the pressure information.

3. The information processing apparatus according to claim 2, wherein
the estimation unit
calculates a change amount in the pressure applied by the object to the surface of the target, and
the determination unit
determines whether to alter the firmness of the surface of the target based on the change amount in the pressure.

4. The information processing apparatus according to claim 3, wherein
the determination unit
determines to alter the firmness of the surface of the target in a case where the change amount in the pressure is a threshold or more.

5. The information processing apparatus according to claim 3, wherein
the determination unit
determines to alter the firmness of the surface of the target in a case where a gesture corresponding to a pressure change pattern satisfies a condition.

6. The information processing apparatus according to claim 3, wherein
the determination unit
determines an alteration amount in the firmness of the surface of the target according to the change amount in the pressure.

7. The information processing apparatus according to claim 3, wherein
the acquisition unit
acquires the sensor information including the pressure information indicating a pressure to each of a plurality of regions on the surface of the target,
the estimation unit
calculates, based on the pressure information, the change amount in the pressure applied by the object to each of the plurality of regions on the surface of the target, and
the determination unit
determines a region in which the change amount in the pressure satisfies a condition, among the plurality of regions on the surface of the target, as a region to undergo firmness alteration.

8. The information processing apparatus according to claim 1, wherein
the acquisition unit
acquires the sensor information including image information imaged by an image sensor, and
the estimation unit
estimates the contact mode of the object with the surface of the target based on the image information.

9. The information processing apparatus according to claim 8, wherein
the estimation unit
calculates an intersection between a feature point of the object and the surface of the target by using a moving direction of the object based on the image information, and
the determination unit
determines to alter the firmness of the surface of the target in a case where a distance between the feature point of the object and the intersection is a threshold or more.

10. The information processing apparatus according to claim 9, wherein
the determination unit
determines an alteration amount in the firmness of the surface of the target according to a moving speed of the object.

11. The information processing apparatus according to claim 9, wherein
the estimation unit
estimates a context related to the object based on the image information, and
the determination unit
determines to alter the firmness of the surface of the target in a case where the context estimated by the estimation unit satisfies a condition.

12. The information processing apparatus according to claim 11, wherein
the determination unit
determines an alteration amount in the firmness of the surface of the target according to the context.

13. The information processing apparatus according to claim 8, wherein
the acquisition unit
acquires the sensor information including the image information obtained by imaging a user by the image sensor,
the estimation unit
estimates information related to the user based on the image information, and
the determination unit
determines whether to alter the firmness of the surface of the target based on the information related to the user estimated by the estimation unit.

14. The information processing apparatus according to claim 8, wherein
the estimation unit
estimates the contact mode of the object with respect to a plurality of regions on the surface of the target based on the image information, and
the determination unit
determines a region in which the contact mode satisfies a condition among the plurality of regions on the surface of the target, as a region to undergo firmness alteration.

15. An information processing method comprising:
acquiring sensor information detected by a sensor;
estimating, based on the acquired sensor information, a contact mode of an object with respect to a target of which a firmness of a surface is alterable; and
determining whether to alter the firmness of the surface of the target according to the estimated contact mode of the object.

16. A firmness alterable module constituting at least a part of a surface of a target, the firmness alterable module comprising:
a sheet-like coupling portion that is disposed along the surface and is flexible in a direction intersecting the surface;
a block portion having a plurality of blocks disposed side by side along a back surface and coupled to the back surface, the back surface being a surface opposite to the surface of the coupling portion; and
a softness/firmness controller that is disposed along one surface of each of the plurality of blocks with the block portion interposed between the softness/firmness controller and the coupling portion, the softness/firmness controller being capable of altering firmness.

17. The firmness alterable module according to claim 16, wherein
each of the plurality of blocks is
a hexahedron in which a facing surface facing the one surface is coupled to the coupling portion, and surfaces other than the one surface and the facing surface are disposed adjacent to surfaces of other blocks.

18. The firmness alterable module according to claim 16, wherein
the softness/firmness controller includes:
a flexible member disposed along one surface of each of the plurality of blocks; and
a pressing mechanism that presses the flexible member toward the block portion from a position where the block portion and the flexible member are sandwiched.

19. The firmness alterable module according to claim 18, wherein
the pressing mechanism includes:
a movable portion having a plate shape along the flexible member at a position sandwiching the block portion and the flexible member; and
a drive unit that moves the movable portion in a direction intersecting the surface.

20. The firmness alterable module according to claim 16, further comprising
a cover portion that covers the coupling portion, the block portion, and the softness/firmness controller, and to which an object comes in contact with a surface being an opposite surface of a surface running along the coupling portion.
